(19) United States
(12) Patent Application Publication
(10) Pub. No.: US 2018/0176289 A1
(43) Pub. Date: Jun. 21, 2018

(54) INFORMATION PROCESSING DEVICE, INFORMATION PROCESSING SYSTEM, COMPUTER-READABLE RECORDING MEDIUM, AND INFORMATION PROCESSING METHOD

(71) Applicant: FUJITSU LIMITED, Kawasaki-shi (JP)

(72) Inventor: Kazuhiro Watanabe, Kawasaki (JP)

(73) Assignee: FUJITSU LIMITED, Kawasaki-shi (JP)

(21) Appl. No.: 15/803,990

(22) Filed: Nov. 6, 2017

(30) Foreign Application Priority Data
Dec. 15, 2016 (JP) 2016-243006

(51) Int. Cl. H04L 29/08; H04L 12/919; G06F 9/455; G06F 9/50

(52) U.S. Cl. CPC H04L 67/101; H04L 67/1008; H04L 61/103; G06F 9/45558; G06F 9/5077; H04L 47/765

(57) ABSTRACT

A remote router information collection unit acquires information of traffic of a remote router. An information collection unit acquires information of traffic of a load balancer, a virtual machine, and a virtual router. The load balancer control unit causes a server device to execute preparation for increase or decrease of the load balancer on the basis of the information of traffic of the remote router and the virtual router, and to increase or decrease the load balancer on the basis of the information of traffic of the load balancer. A virtual machine control unit causes a server device to execute preparation for increase or decrease the virtual machine on the basis of the information of traffic of the load balancer, and to increase or decrease the virtual machine on the basis of the information of traffic of the virtual machine.

### CROSS-REFERENCE TO RELATED APPLICATION

This application is based upon and claims the benefit of priority of the prior Japanese Patent Application No. 2016-243006, filed on Dec. 15, 2016, the entire contents of which are incorporated herein by reference.

### FIELD

The embodiments discussed herein are related to an information processing device, an information processing system, an information processing program, and an information processing method.

### BACKGROUND

In recent years, an information processing device can be used in various environments such as in a company, at home, or at a place where a user has visited, with the popularization of information processing devices. Cloud systems have been in widespread use in response to a request to access common data from the information processing devices arranged in the various environments. A cloud system is a system in which a user uses software or data in a server on a computer network through the network.

Such a cloud system has functions of various web services mounted, and the user can get the various web services from one cloud system. In a case where functions of a plurality of web services are mounted on the cloud system, change of traffic regarding the web services becomes complicated. Therefore, the cloud system is requested to automatically increase resources used by the web services in accordance with the change of traffic. Hereinafter, the automatic increase in the resources used by the web services is called “autoscale”.

Conventionally, as autoscale methods, a method of increasing a resource when a resource in use has reached performance upper limit, a method of forcibly deploying a resource to increase resources, and a method of deploying a substitute when abnormality occurs in a resource in use are known.

Further, as an autoscale technology, there is a conventional technology to arrange load balancers at a front stage of servers in a cloud system, increase or decrease the servers according to loads on the servers, and cause the load balancers to allocate processing to the increased or decreased servers. Further, there is a conventional technology to perform load calculation of servers and perform autoscale according to a result of the load calculation in a server group in a tree structure. Further, there is a conventional technology to change allocation of resources of business nodes to perform load measurement to be used as a base for autoscale, perform the load measurement, and identify an influence range due to relevancy between the business nodes, using the result.

Patent Document 1: Japanese Laid-open Patent Publication No. 2014-48900

Patent Document 2: International Publication Pamphlet No. WO 2015/145753

Patent Document 3: International Publication Pamphlet No. WO 2015/121925

However, in the method of increasing a resource when a resource in use has reached performance upper limit, a traffic amount of the resource in use is measured and autoscale is executed according to change of the traffic amount. Therefore, even if a rapid increase in the traffic amount occurs, change of the traffic amount is recognized and the autoscale is started after the resource reaches the performance upper limit. That is, a time lag between occurrence of the increase in the traffic amount and the start of the autoscale is large. No action is taken during this time lag, and thus there is a possibility of occurrence of an over-performance state of the resource. Therefore, it is difficult to perform appropriate autoscale according to change of the traffic amount.

### SUMMARY

According to an aspect of an embodiment, an information processing device includes: an information acquisition unit that acquires information of traffic of a communication processing device and a virtual resource to be used in transmission or reception of data to or from a calculation processing device that operates the virtual resource; and a control unit that causes the calculation processing device to execute preparation for increase or decrease of the virtual resource on the basis of the information of traffic of the communication processing device and causes the calculation processing device to increase or decrease the virtual resource on the basis of the information of traffic of the virtual resource.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a cloud system having an autoscale function;

FIG. 2 is a block diagram of a cloud management device;

FIG. 3 is a diagram illustrating an example of a resource management database;

FIG. 4 is a diagram illustrating an example of an information storage database;

FIG. 5 is a diagram illustrating an example of pool information;

FIG. 6 is a diagram illustrating an example of an analysis learning database according to a first embodiment;

FIG. 7 is a sequence diagram of information collection processing by a cloud management device;

FIG. 8 is a sequence diagram of information analysis processing regarding scale out by the cloud management device according to the first embodiment;

FIG. 9 is a sequence diagram of scale-out processing of a load balancer by the cloud management device according to the first embodiment;

FIG. 10 is a sequence diagram of scale-out processing of a virtual machine by the cloud management device according to the first embodiment;

FIG. 11 is a sequence diagram of information analysis processing regarding scale in by the cloud management device according to the first embodiment;

FIG. 12 is a sequence diagram of scale-in processing of the load balancer by the cloud management device according to the first embodiment;

FIG. 13 is a sequence diagram of scale-in processing of the virtual machine by the cloud management device according to the first embodiment;

FIG. 14 is a diagram illustrating an example of an analysis learning database according to a second embodiment;

FIG. 15 is a sequence diagram of information analysis processing regarding scale out by a cloud management device according to the second embodiment;

FIG. 16 is a sequence diagram of scale-out processing of a load balancer by the cloud management device according to the second embodiment;

FIG. 17 is a sequence diagram of scale-out processing of a virtual machine by the cloud management device according to the second embodiment;

FIG. 18 is a sequence diagram of information analysis processing regarding scale in by the cloud management device according to the second embodiment;

FIG. 19 is a sequence diagram of scale-in processing of the load balancer by the cloud management device according to the second embodiment;

FIG. 20 is a sequence diagram of scale-in processing of the virtual machine by the cloud management device according to the second embodiment;

FIG. 21 is a sequence diagram of scale-out processing of a load balancer by a cloud management device according to a third embodiment;

FIG. 22 is a sequence diagram of scale-out processing of a virtual machine by the cloud management device according to the third embodiment; and

FIG. 23 is a hardware configuration diagram of a cloud management device.

### DESCRIPTION OF EMBODIMENTS

Preferred embodiments of the present invention will be explained with reference to accompanying drawings. Note that the information processing device, the information processing system, the information processing program, and the information processing method disclosed by the present application are not limited by the embodiments below.

### [a] First Embodiment

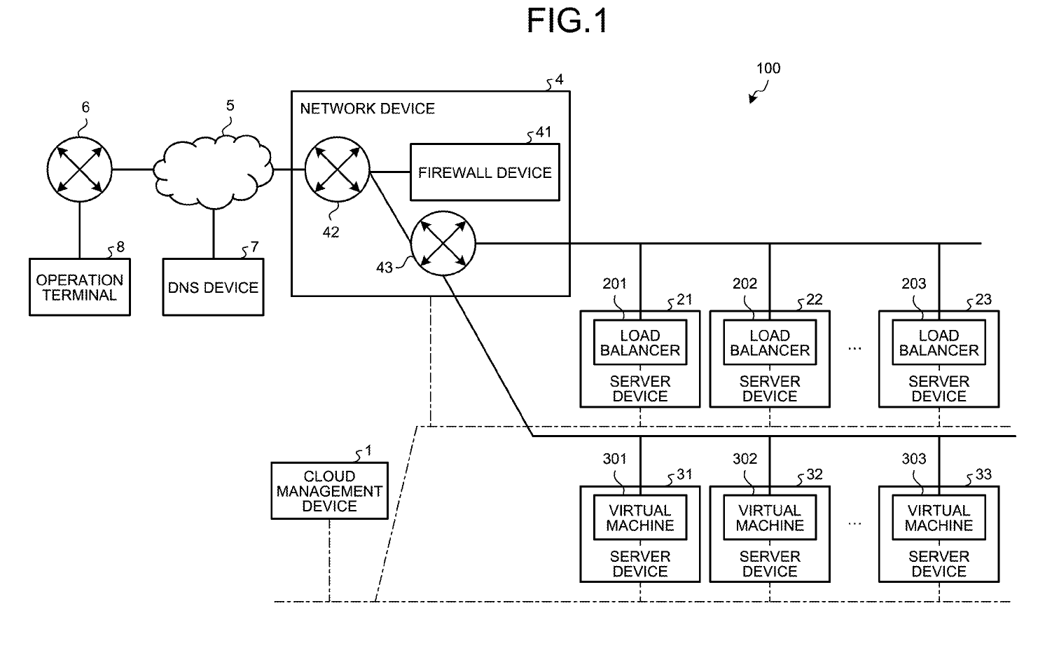

FIG. 1 is a configuration diagram of a cloud system having an autoscale function. A cloud system 100 includes a cloud management device 1, a network device 4, a remote router 6, a domain name service (DNS) device 7, and server devices 21 to 23 and 31 to 33.

The one-dot chain lines in FIG. 1 illustrate a management network for managing the cloud system 100. Further, the solid lines in FIG. 1 illustrate a business network that provides a service of the cloud system 100.

The server devices 21 to 23 and 31 to 33 are connected to a network 5 for providing services of the server devices 31 to 33 to an operation terminal 8 through the network device 4. Further, the DNS device 7 is connected to the network 5. Further, a remote router 6 is connected to the network 5. Then, the DNS device 7 and the server devices 21 to 23 and 31 to 33 are connected to the operation terminal 8 through the remote router 6.

The server devices 21 to 23 respectively operate load balancers 201 to 203. The load balancers 201 to 203 allocate a processing request transmitted from the operation terminal 8 to virtual machines 301 to 303 described below to perform load distribution. The plurality of load balancers 201 to 203 realizes a function of one load balancer. To be specific, the load balancers 201 to 203 includes information of a virtual internet protocol (IP) address for an access from the operation terminal 8 and IP addresses of the virtual machines 301 to 303 as distribution destinations. The server devices 21 to 23 have the same function. Therefore, in a case where the server devices 21 to 23 are not distinguished from one another, the server devices 21 to 23 are simply referred to as “server device 20”. Further, the load balancers 201 to 203 have the same function. Therefore, in a case where the load balancers 201 to 203 are not distinguished from one another, the load balancers 201 to 203 are simply referred to as “load balancer 200”. The load balancer 200 corresponds to an example of “a device that mediates transmission or reception of data to or from a virtual machine”.

The server devices 31 to 33 respectively operate the virtual machines 301 to 303. The virtual machines 301 to 303 receive the processing request transmitted from the operation terminal 8 and execute processing according to the received processing request. The server devices 31 to 33 have the same function. Therefore, in a case where the server devices 31 to 33 are not distinguished from one another, the server devices 31 to 33 are simply referred to as “server device 30”. Further, the virtual machines 301 to 303 have the same function. Therefore, in a case where the virtual machines 301 to 303 are not distinguished from one another, the virtual machines 301 to 303 are simply referred to as “virtual machine 300”. The load balancer 200 and the virtual machine 300 correspond to examples of “virtual resources”. Further, the server devices 20 and 30 correspond to examples of “calculation processing devices”.

The network device 4 includes a firewall device 41 and virtual routers 42 and 43. The firewall device 41 restricts accesses to the server devices 20 and 30 to secure safety. The firewall device 41 is connected to a path that connects the network 5 and the server devices 20 and 30, using the virtual router 42 as a connection point, and monitors accesses on the network.

The virtual router 42 is a router connected with the network 5. Further, the virtual router 43 is a router connected with the server devices 20 and 30 The load balancer 200 and the virtual machine 300 are connected to the network 5 through the virtual routers 42 and 43. Here, in the present embodiment, the virtual routers 42 and 43 are used to connect the server devices 20 and 30 to the network 5. However, physical routers may be used. Hereinafter, in a case where the virtual routers 42 and 43 are not distinguished from each other, the virtual routers 42 and 43 may be simply referred to as “virtual router 40”.

The DNS device 7 solves names of the load balancer 200 and the virtual machine 300. The DNS device 7 stores identification information such as resource names of the load balancer 200 and the virtual machine 300, and the IP addresses, in association with each other. The DNS device 7 then responds with the IP address corresponding to the identification information of which an inquiry has been received, in response to a request of name solution from the operation terminal 8.

The remote router 6 is a base router arranged in a base where a business of a company is performed, for example. The operation terminal 8 is a terminal device for performing a business of a company. The operation terminal 8 is connected to the network 5 through the remote router 6. The operation terminal 8 accesses the load balancer 200, using the IP address notified from the DNS device 7 on the basis of the name of the load balancer 200, and has the load distribution performed by the load balancer 200, thereby to receive the services provided by the virtual machines 301 to 303.

Here, transmission or reception of data between the operation terminal 8 and the load balancer 200 is performed through the remote router 6 and the virtual router 40. That is, the remote router 6 and the virtual router 40 correspond to an example of “a communication processing device used in transmission or reception of data” for the load balancer 200. Further, transmission or reception of data between the operation terminal 8 and the virtual machine 300 is performed through the remote router 6, the virtual router 40, and the load balancer 200. That is, the remote router 6, the virtual router 40, and the load balancer 200 correspond to an example of “a communication processing device used in transmission or reception of data” for the virtual machine 300.

The cloud management device 1 accesses the server devices 20 and 30 through a management network. Further, the cloud management device 1 accesses the remote router 6 and the DNS device 7 through the network device 4 and the network 5, in addition to the management network.

The cloud management device 1 generates the specified virtual routers 42 and 43 in the network device 4. Further, the cloud management device 1 starts and deploys the load balancer 200 in the server device 20. Further, the cloud management device 1 starts and deploys the virtual machine 300 in the server device 30.

Further, the cloud management device 1 acquires load information such as traffic of the remote router 6, the virtual routers 42 and 43, the load balancer 200, and the virtual machine 300. The cloud management device 1 then executes autoscale, that is, increase and reduction of the load balancer 200 and the virtual machine 300, using the acquired load information. Hereinafter, details of the cloud management device 1 will be described. The cloud management device 1 is an information processing device. Further, the cloud management device 1 corresponds to an example of “a management device”.

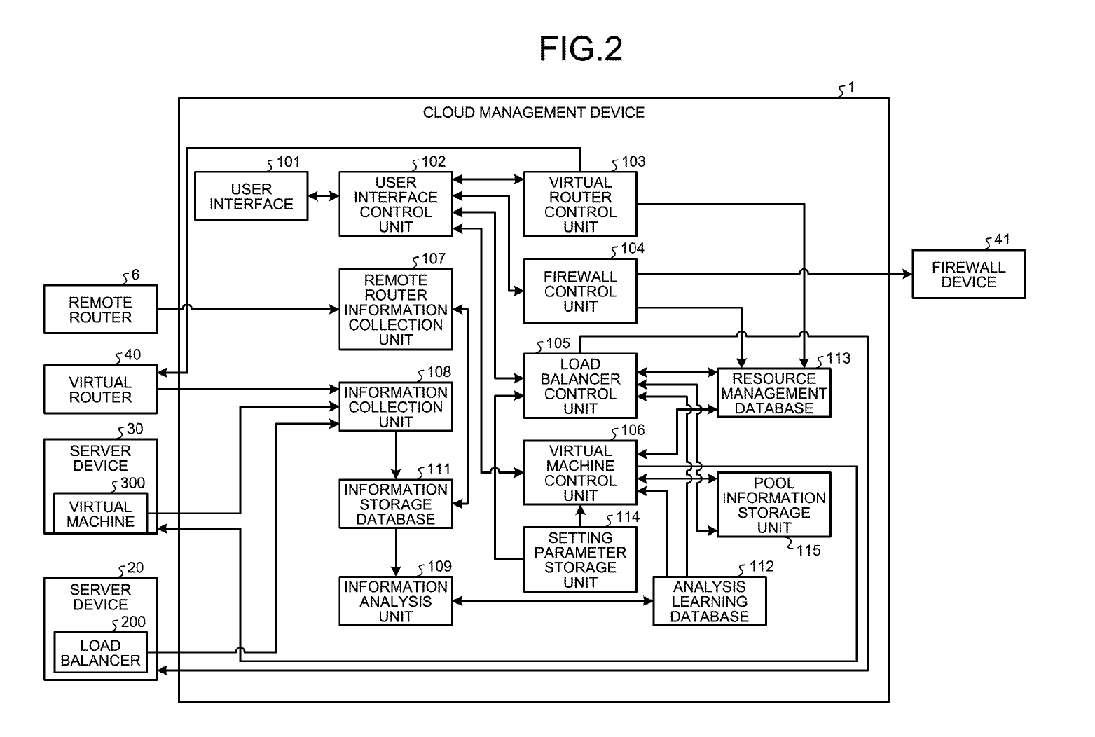

FIG. 2 is a block diagram of a cloud management device. The cloud management device 1 includes a user interface 101, a user interface control unit 102, a virtual router control unit 103, a firewall control unit 104, a load balancer control unit 105, a virtual machine control unit 106, a remote router information collection unit 107, and an information collection unit 108. Further, the cloud management device 1 includes an information storage database 111, an analysis learning database 112, a resource management database 113, a setting parameter storage unit 114, and a pool information storage unit 115.

The user interface 101 includes an input device such as a keyboard, and a mouse and an output device such as a monitor, for example. The user interface 101 provides a graphic user interface (GUI), a command line interface (CLI), or an application programming interface (API), or the like. An operator inputs a processing request, data, or the like to the cloud management device 1, using the user interface 101.

The user interface control unit 102 transmits the processing request or data input through the user interface 101 to the virtual router control unit 103, the firewall control unit 104, the load balancer control unit 105, or the virtual machine control unit 106. Further, the user interface control unit 102 receives data such as responses to the processing request, from the virtual router control unit 103, the firewall control unit 104, the load balancer control unit 105, and the virtual machine control unit 106. The user interface control unit 102 then provides the received data to the operator, using the user interface 101.

The virtual router control unit 103 receives setting information of deployment and performance information collection of the virtual router 40, and the like input by the operator, through the user interface control unit 102. The virtual router control unit 103 then performs control to set the deployment and the performance information collection of the virtual router 40 according to the received setting information. The virtual router control unit 103 then displays an execution result of the setting in the user interface 101 through the user interface control unit 102. Further, the virtual router control unit 103 registers deployed resource information including a resource type, a resource name, and a resource identifier (ID) of the virtual router 40 to the resource management database 113.

The firewall control unit 104 receives setting information of deployment, a rule, and performance information collection of the firewall device 41, and the like input by the operator, through the user interface control unit 102. The firewall control unit 104 performs control to set the deployment, the rule, and the performance information collection of the firewall device 41 according to the received setting information. The firewall control unit 104 then displays an execution result of the setting in the user interface 101 through the user interface control unit 102. Further, the firewall control unit 104 registers deployed resource information of the firewall device 41 to the resource management database 113.

The remote router information collection unit 107 acquires transmission source network information of communication addressed to the load balancer 200 from the information storage database 111. Next, the remote router information collection unit 107 identifies a path interface in the remote router 6 serving as a transmission source of the processing request to the load balancer 200 from the transmission source network information of communication addressed to the load balancer 200. The remote router information collection unit 107 then updates traffic acquisition information to the remote router 6, using the identified path interface. Here, the traffic acquisition information is information of the registered path interface that is an interface to a transmission source network in the remote router 6 and is an interface that is an acquisition target of traffic information.

The remote router information collection unit 107 transmits the traffic acquisition information to the remote router 6 to request transmission of the traffic information. After that, the remote router information collection unit 107 periodically collects the traffic information of the identified path interface of the remote router 6 from the remote router 6, and stores the collected traffic information to the information storage database 111. For example, the remote router information collection unit 107 collects the traffic information of the path interface every one minute.

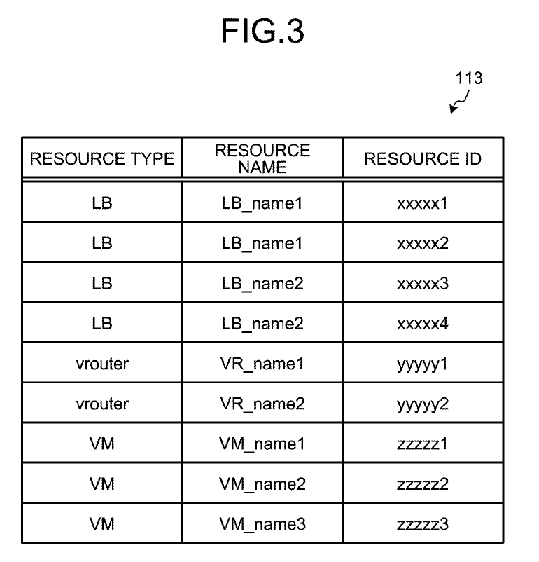

The resource management database 113 has a format illustrated in FIG. 3, for example. FIG. 3 is a diagram illustrating an example of a resource management database. In the present embodiment, in the resource management database 113, the resource type that indicates a type of a resource, the resource name that is a name given to the resource, and the resource ID that is an identifier of the resource are registered. In FIG. 3, LB (load balancer) in the resource type indicates that the resource is the load balancer 200. Further, vrouter (virtual router) in the resource type indicates that the resource is the virtual router 40. Further, VM (virtual machine) in the resource type indicates that the resource is the virtual machine 300.

The resource management database 113 acquires the deployed resource information of the virtual router 40 from the virtual router control unit 103. The resource management database 113 then registers and stores the acquired deployed resource information of the virtual router 40. Further, the resource management database 113 acquires the deployed resource information of the firewall device 41 from the firewall control unit 104. The resource management database 113 then registers and stores the acquired deployed resource information of the firewall device 41. Further, the resource management database 113 acquires the deployed resource information of the load balancer 200 from the load balancer control unit 105. The resource management database 113 then registers and stores the acquired deployed resource information of the load balancer 200. Further, the resource management database 113 acquires the deployed resource information of the virtual machine 300 from the virtual machine control unit 106. The resource management database 113 then registers and stores the acquired deployed resource information of the virtual machine 300.

The information collection unit 108 acquires traffic information of the virtual router 40, the load balancer 200, and the virtual machine 300. Further, the information collection unit 108 collects the transmission source network information addressed to the load balancer 200. The information collection unit 108 then stores the traffic information and the transmission source network information to the information storage database 111. The remote router information collection unit 107 and the information collection unit 108 correspond to an example of “an information acquisition unit”.

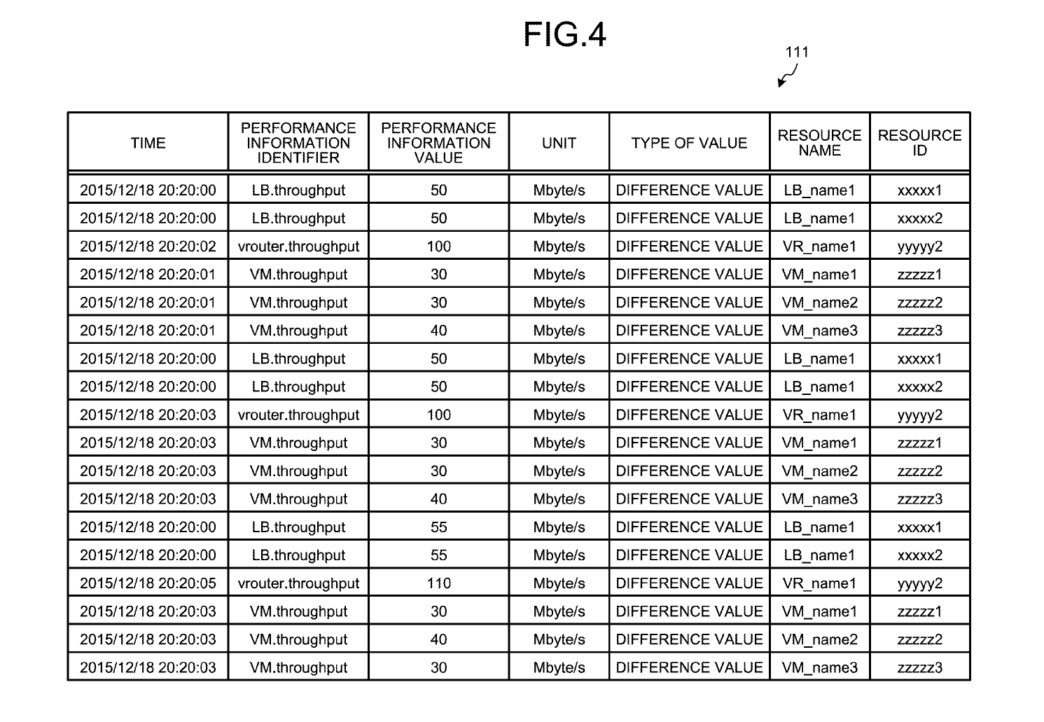

The information storage database 111 has a format illustrated in FIG. 4, for example. FIG. 4 is a diagram illustrating an example of an information storage database. For example, in the information storage database 111, a time when performance information is acquired, a performance information identifier that is an identifier of the performance information, a value of the performance information, and a unit of the performance information are registered. Further, in the information storage database 111, a type of a value that indicates what value the performance information has, and a resource name and a resource ID allocated to the performance information are registered. Here, a difference value in the type of a value is a value of a difference between a value at the time of previous measurement and a value at the time of current measurement.

Further, the transmission source network information of communication addressed to the load balancer 200 is also stored in the information storage database 111 although not illustrated in FIG. 4.

The information storage database 111 stores the traffic information of the path interface of the remote router 6 acquired from the remote router information collection unit 107. Further, the information storage database 111 stores the traffic information of the virtual router 40, the load balancer 200, and the virtual machine 300 acquired from the information collection unit 108. Further, the information storage database 111 stores the transmission source network information of communication addressed to the load balancer 200 acquired from the information collection unit 108.

The setting parameter storage unit 114 stores various parameters to be used to operate the cloud management device 1. For example, the setting parameter storage unit 114 stores parameters for deploying and setting the load balancer 200 and the virtual machine 300.

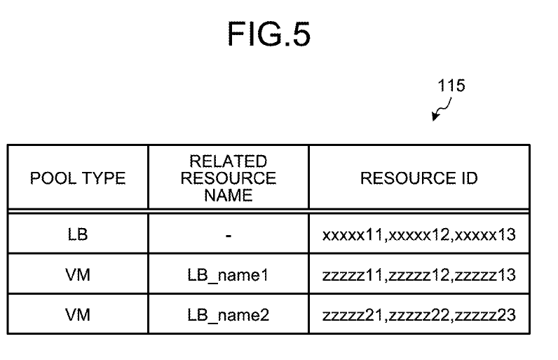

The pool information storage unit 115 stores information of the load balancer 200 stored in an LB pool that accommodates the load balancer 200 before deployment and the virtual machine 300 stored in a VM pool that accommodates the virtual machine 300 before deployment. The pool information storage unit 115 has a format illustrated in FIG. 5, for example. FIG. 5 is a diagram illustrating an example of pool information. In the pool information storage unit 115, a pool type that indicates either the LB pool or the VM pool, a related resource name that indicates the load balancer 200 related to the VM pool, and a resource ID of a device stored in each pool.

The pool information storage unit 115 receives an instruction of storage of the load balancer 200 to the LB pool, from the load balancer control unit 105. The pool information storage unit 115 then registers the resource ID of the specified load balancer 200 in association with the specified LB pool. Further, the pool information storage unit 115 receives an instruction of deletion of the load balancer 200 from the LB pool, from the load balancer control unit 105. The pool information storage unit 115 then deletes the resource ID of the specified load balancer 200 from the specified LB pool.

Further, the pool information storage unit 115 receives an instruction of storage of the virtual machine 300 to the VM pool, from the virtual machine control unit 106. The pool information storage unit 115 then registers the resource ID of the specified virtual machine 300 in association with the specified VM pool. Further, the pool information storage unit 115 receives an instruction of deletion of the virtual machine 300 from the VM pool, from the virtual machine control unit 106. The pool information storage unit 115 then deletes the resource ID of the specified virtual machine 300 from the specified VM pool.

An information analysis unit 109 determines whether executing autoscale or preparation for autoscale of the load balancer 200 and the virtual machine 300, using the traffic information in the devices. Here, preparation for autoscale refers to storage of the load balancer 200 and the virtual machine 300 to the LB pool and the VM pool in advance for scale out. To be specific, the information analysis unit 109 performs the following processing.

The information analysis unit 109 preforms processing of setting autoscale of the load balancer 200 as follows, using a traffic amount in the load balancer 200.

The information analysis unit 109 acquires the traffic information of the load balancer 200 from the information storage database 111. To be specific, the information analysis unit 109 acquires a total value of the traffic amounts of the load balancers 200. Next, the information analysis unit 109 determines whether the traffic amount of the load balancer 200 has reached a performance upper limit of the load balancer 200. In a case where the traffic amount has reached the performance upper limit of the load balancer 200, the information analysis unit 109 registers basic information such as acquisition time and identification information of the traffic information to the analysis learning database 112. Further, the information analysis unit 109 sets an LB scale-out trigger serving as a trigger of immediate execution start of scale out of the load balancer 200 to a registered entry.

Meanwhile, in a case where the traffic amount has not reached the performance upper limit of the load balancer 200, the information analysis unit 109 determines whether the traffic amount of the load balancer 200 is 1.5 times or more of the previously measured traffic amount. To be specific, the information analysis unit 109 obtains a value that is obtained by dividing a total of the traffic amounts of all the load balancers 200 in operation by the number of the load balancers 200 in operation. The information analysis unit 109 then confirms whether the obtained value is 1.5 times or more of a value that is obtained by dividing a total of the traffic amounts of all the load balancers 200 in operation in previous measurement by the number of the load balancers 200 in operation. Here, in the present embodiment, occurrence of rapid increase in the traffic amount is determined in a case where the traffic amount is 1.5 times or more of the previous amount. However, this value may be another value and is favorably set according to an operation state of the cloud system 100. In a case where the traffic amount is 1.5 times or more of the previous traffic amount, the information analysis unit 109 registers the basic information such as acquisition time and identification information of the traffic information to the analysis learning database 112. Further, the information analysis unit 109 sets preparation for scale out of the load balancer 200, that is, LB scale-out preparation that is a value to instruct storage of the load balancer 200 to be added to the LB pool, to the registered entry.

Further, the information analysis unit 109 determines whether the traffic amount of the load balancer 200 is 0.5 times or less the previously measured traffic amount. To be specific, the information analysis unit 109 obtains a value that is obtained by dividing a total of the traffic amounts of all the load balancers 200 in operation by the number of the load balancers 200 in operation. The information analysis unit 109 then confirms whether the obtained value is 0.5 times or less a value that is obtained by dividing a total of the traffic amounts of all the load balancers 200 in operation in previous measurement by the number of the load balancers 200 in operation. Here, in the present embodiment, occurrence of decrease in the traffic amount is determined in a case where the traffic amount is 0.5 times or less the previous amount. However, this value may be another value and is favorably set according to an operation state of the cloud system 100. In a case where the traffic amount is 0.5 times or less the previous traffic amount, the information analysis unit 109 registers the basic information such as acquisition time and identification information of the traffic information to the analysis learning database 112. Further, the information analysis unit 109 sets LB scale-in preparation to the registered entry.

Further, the information analysis unit 109 preforms processing of setting autoscale preparation of the load balancer 200, using a traffic amount of a resource at a front stage, as follows.

The information analysis unit 109 acquires the traffic information of the virtual router 40 from the information storage database 111. To be specific, the information analysis unit 109 acquires a total value of the traffic amounts addressed to the load balancer 200, in the virtual router 40. Next, the information analysis unit 109 determines whether the traffic amount of the virtual router 40 is 1.5 times or more of the previously measured traffic amount. To be specific, the information analysis unit 109 confirms whether the total of the traffic amounts of the virtual routers 40 of this time is 1.5 times or more of the total of the traffic amounts of the virtual routers 40 of the previous time. In a case where the traffic amount is 1.5 times or more of the previous traffic amount, the information analysis unit 109 registers the basic information such as acquisition time and identification information of the traffic information to the analysis learning database 112. Further, the information analysis unit 109 sets the LB scale-out preparation to the registered entry.

Further, the information analysis unit 109 acquires the traffic information of the remote router 6 from the information storage database 111. To be specific, the information analysis unit 109 acquires the traffic information of the path interface of the remote router 6. The information analysis unit 109 then determines whether the traffic amount of the remote router 6 is 1.5 times or more of a previously measured traffic amount. To be specific, the information analysis unit 109 confirms whether the traffic amount of the remote router 6 of this time is 1.5 times or more of the traffic amount of the remote router 6 of the previous time. In a case where the traffic amount is 1.5 times or more of the previous traffic amount, the information analysis unit 109 registers the basic information such as acquisition time and identification information of the traffic information to the analysis learning database 112. Further, the information analysis unit 109 sets the LB scale-out preparation to the registered entry.

Further, the information analysis unit 109 performs processing of setting autoscale of the virtual machine 300 as follows.

The information analysis unit 109 acquires the traffic information of the virtual machine 300 from the information storage database 111. To be specific, the information analysis unit 109 acquires a total value of the traffic amounts of the virtual machines 300 registered in the load balancer 200. The information analysis unit 109 then determines whether the traffic amount of the virtual machine 300 has reached an upper limit of the traffic amount of the virtual machine 300. To be specific, the information analysis unit 109 obtains a value that is obtained by diving a total of traffic amounts of ports that perform transmission or reception of data to or from the load balancer 200 of the virtual machine 300 by the number of the virtual machines 300. Further, the information analysis unit 109 acquires a traffic performance value of the virtual machine 300 and an upper limit threshold of traffic performance of the virtual machine 300 from the setting parameter storage unit 114. Here, the upper limit threshold of traffic performance is expressed by a percentage of a case where the traffic performance value is 100%. The information analysis unit 109 then confirms whether the traffic amount has reached the upper limit of the traffic amount according to whether a value obtained by multiplying the traffic performance value of the virtual machine 300 by the upper limit threshold of the traffic performance of the virtual machine 300 and dividing the product by 100 is the value obtained this time or more.

In a case where the traffic amount of the virtual machine 300 has reached the upper limit of the virtual machine 300, the information analysis unit 109 registers the basic information such as acquisition time and identification information of the traffic information to the analysis learning database 112. Further, the information analysis unit 109 sets a VM scale-out trigger serving as a trigger of immediate execution start of scale out of the virtual machine 300 to the registered entry.

Further, the information analysis unit 109 determines whether the traffic amount of the load balancer 200 has reached a performance upper limit of the virtual machine 300. To be specific, the information analysis unit 109 obtains a value that is obtained by dividing a total of the traffic amounts of all the load balancers 200 by the number of the load balancers 200 and dividing the quotient by the number of the virtual machines 300. The information analysis unit 109 then preforms determination according to whether the obtained value is smaller than the value obtained by multiplying the traffic performance value of the virtual machine 300 by the upper limit threshold of the traffic performance of the virtual machine 300 and dividing the product by 100.

In a case where the traffic amount of the load balancer 200 has reached the performance upper limit of the virtual machine 300, the information analysis unit 109 registers the basic information such as acquisition time and identification information of the traffic information to the analysis learning database 112. Further, the information analysis unit 109 sets the VM scale-out trigger to the registered entry.

Further, the information analysis unit 109 determines whether the traffic amount of the virtual machine 300 has been reduced to a state where the virtual machine 300 is reducible. To be specific, the information analysis unit 109 obtains a value that is obtained by diving a total of traffic amounts of ports that perform transmission or reception of data to or from the load balancer 200 of the virtual machine 300 by the number of the virtual machines 300. Further, the information analysis unit 109 acquires the traffic performance value of the virtual machine 300 and a lower limit threshold of the traffic performance of the virtual machine 300 from the setting parameter storage unit 114. Here, the lower limit threshold of the traffic performance is expressed by a percentage of a case where the traffic performance value is 100%. For example, the lower limit threshold of the traffic performance of the virtual machine 300 is set to 20%. Here, the lower limit threshold of the traffic performance of the virtual machine 300 is favorably set according to an operation state of the cloud system 100. The information analysis unit 109 confirms whether the traffic amount has been reduced to a state where the virtual machine 300 is reducible according to whether a value obtained by multiplying the traffic performance value of the virtual machine 300 by the lower limit threshold of the traffic performance of the virtual machine 300 and dividing the product by 100 is the value obtained this time or less.

In a case where the traffic amount of the virtual machine 300 has been reduced to the state where the virtual machine 300 is reducible, the information analysis unit 109 registers the basic information such as acquisition time and identification information of the traffic information to the analysis learning database 112. Further, the information analysis unit 109 sets VM scale-in preparation to the registered entry.

Further, the information analysis unit 109 determines whether the traffic amount of the load balancer 200 has reached a performance lower limit of the virtual machine 300. To be specific, the information analysis unit 109 obtains a value that is obtained by dividing a total of the traffic amounts of all the load balancers 200 by the number of the load balancers 200 and dividing the quotient by the number of the virtual machines 300. The information analysis unit 109 then preforms determination according to whether the obtained value is smaller than the value obtained by multiplying the traffic performance value of the virtual machine 300 by the lower limit threshold of the traffic performance of the virtual machine 300 and dividing the product by 100.

In a case where the traffic amount of the load balancer 200 has reached the performance lower limit of the virtual machine 300, the information analysis unit 109 registers the basic information such as acquisition time and identification information of the traffic information to the analysis learning database 112. Further, the information analysis unit 109 sets VM scale-in preparation to the registered entry.

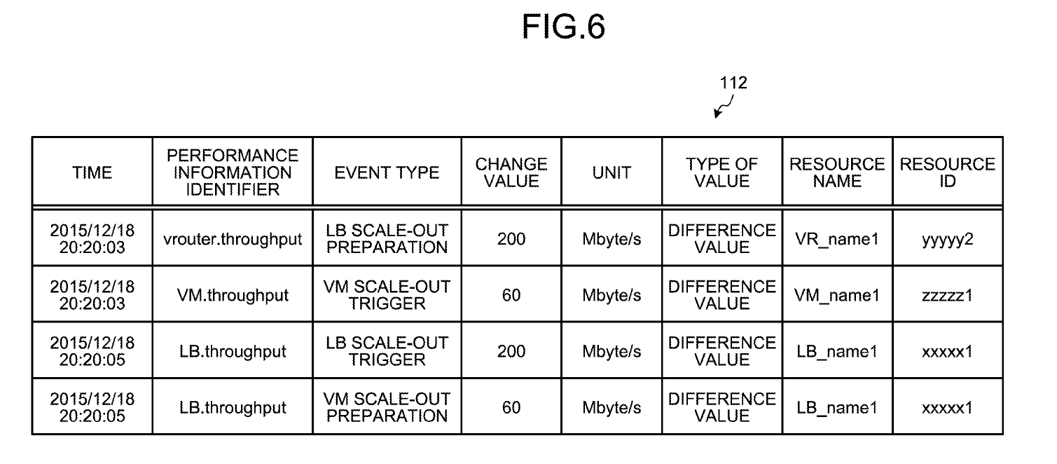

The analysis learning database 112 has a format illustrated in FIG. 6, for example. FIG. 6 is a diagram illustrating an example of an analysis learning database according to a first embodiment. For example, in the analysis learning database 112, a time when performance information is acquired, a performance information identifier that is an identifier of the performance information, a change value of the performance information, and a unit of the performance information are registered. Further, in the information storage database 111, a type of a value that indicates what value the performance information has, and a resource name and a resource ID allocated to the performance information are registered. Further, in the analysis learning database 112, an event type that indicates processing performed according to the performance information is stored.

Examples of the event type include, in the present embodiment, the LB scale-out trigger, the LB scale-out preparation, the LB scale-in preparation, the VM scale-out trigger, VM scale-out preparation, and the VM scale-in preparation. The LB scale-out trigger is a value serving as a trigger of immediate execution start of scale out of the load balancer 200. The LB scale-out preparation is a value for instructing storage of the load balancer 200 to be added to the LB pool. The LB scale-in preparation is a value for instructing return of a state to a state where the load balancer 200 to be reduced is stored in the LB pool. The VM scale-out trigger is a value serving as a trigger of immediate execution start of scale out of the virtual machine 300. The VM scale-out preparation is a value for instructing storage of the virtual machine 300 to be added to the VM pool. The VM scale-in preparation is a value for instructing return a state to a state where the virtual machine 300 to be reduced is stored in the VM pool.

The load balancer control unit 105 acquires a parameter to be used to set the load balancer 200 from the setting parameter storage unit 114. The load balancer control unit 105 then deploys the load balancer 200 in the server device 20, using the parameter. Further, the load balancer control unit 105 performs setting of performance information collection, and the like. The load balancer control unit 105 then registers information of the deployed load balancer 200 to the resource management database 113.

After start of an operation of the deployed load balancer 200, the load balancer control unit 105 reads the information of the analysis learning database 112. The load balancer control unit 105 then determines whether the LB scale-out trigger has been updated in the analysis learning database 112. In a case where the LB scale-out trigger has been updated, the load balancer control unit 105 calculates increased traffic that is an increased amount of the traffic of the load balancer 200. The load balancer control unit 105 then calculates the number of the load balancers 200 to be added from the increased traffic. Next, the load balancer control unit 105 selects the calculated number of the load balancers 200 from the LB pool, and determines the selected load balancers 200 as the load balancers 200 to be added. The load balancer control unit 105 then registers the IPs of the load balancers 200 to be added to the DNS device 7.

Further, the load balancer control unit 105 determines whether the LB scale-out preparation has been updated in the analysis learning database 112. In a case where the LB scale-out preparation has been updated, the load balancer control unit 105 calculates the number of the load balancers 200 to be added from the increased traffic in the traffic information corresponding to the updated LB scale-out preparation. Next, the load balancer control unit 105 instructs the server device 20 to start the calculated number of the load balancers 200.

Here, in starting the load balancer 200, the load balancer control unit 105 may select the server device 20 to start by the following method, for example. For example, the load balancer control unit 105 acquires use states of the respective resources such as the traffic amounts in the server devices 21 to 23. The load balancer control unit 105 then instructs the server device 20 to start the load balancer 200, the server device 20 having the use state of the resource that is a threshold or less, or the server device 20 having the most sufficient room for the use state of the resource.

After that, the load balancer control unit 105 receives a start completion notification from the server device 20. Upon reception of the start completion notification, the load balancer control unit 105 instructs the server device 20 to reflect the setting to the added load balancers 200. After that, the load balancer control unit 105 receives a setting reflection completion notification from the server device 20. Upon reception of the setting reflection completion notification, the load balancer control unit 105 registers information of the added load balancers 200 to the pool information storage unit 115 to store the added load balancers 200 to the LB pool.

Further, performing the LB scale-out preparation means that an increase in the traffic amount of the load balancer 200 is expected, and a possibility of an increase in the traffic amount of the virtual machine 300 corresponding to the increase in the traffic amount of the load balancer 200 is high. Therefore, the load balancer control unit 105 sets the VM scale-out preparation to the analysis learning database 112.

Further, the load balancer control unit 105 determines whether the LB scale-in preparation has been updated in the analysis learning database 112. In a case where the LB scale-in preparation has been updated, the load balancer control unit 105 calculates the number of the load balancers 200 to be reduced from decreased traffic that is a decreased amount of the traffic of the load balancer 200. Next, the load balancer control unit 105 deletes the IPs of the calculated number of the load balancers 200 from the DNS device 7. The load balancer control unit 105 then stores the load balancers 200 deleted from the DNS device 7 to the LB pool.

The virtual machine control unit 106 acquires a parameter to be used to set the virtual machine 300 from the setting parameter storage unit 114. The virtual machine control unit 106 then deploys the virtual machine 300 in the server device 30, using the parameter. Further, the virtual machine control unit 106 performs setting of a log and performance information collection of the virtual machine 300, and the like. The virtual machine control unit 106 then registers information of the deployed virtual machine 300 to the resource management database 113.

After start of an operation of the deployed virtual machine 300, the virtual machine control unit 106 reads the analysis learning database 112. The virtual machine control unit 106 then determines whether the VM scale-out trigger has been updated. In a case where the VM scale-out trigger has been updated, the virtual machine control unit 106 calculates increased traffic that is an increased amount of the traffic in the traffic information corresponding to the updated VM scale-out trigger. The virtual machine control unit 106 then calculates the number of the virtual machines 300 to be added from the increased traffic. Next, the virtual machine control unit 106 selects the calculated number of the virtual machines 300 from the VM pool, and determines the selected virtual machines 300 as the virtual machines 300 to be added. The virtual machine control unit 106 then notifies the load balancer 200 of the virtual machines 300 to be added.

Further, the virtual machine control unit 106 determines whether the VM scale-out preparation has been updated. In a case where the VM scale-out preparation has been updated, the virtual machine control unit 106 calculates the number of the virtual machines 300 to be added from the increased traffic in the traffic information corresponding to the updated VM scale-out preparation. Next, the virtual machine control unit 106 instructs the server device 30 to start the calculated number of the virtual machines 300. After that, upon reception of a start completion notification, the virtual machine control unit 106 stores the added virtual machines 300 to the VM pool.

Here, in starting the virtual machine 300, the virtual machine control unit 106 may select the server device 30 to start by the following method, for example. For example, the virtual machine control unit 106 acquires use states of the respective resources such as the traffic amounts in the server devices 31 to 33. The virtual machine control unit 106 then instructs the server device 30 to start the virtual machine 300, the server device 30 having the use state of the resource that is a threshold or less, or the server device 20 having the most sufficient room for the use state of the resource.

Further, the virtual machine control unit 106 determines whether the VM scale-in preparation has been updated. In a case where the VM scale-in preparation has been updated, the virtual machine control unit 106 calculates decreased traffic that is a decreased amount of the traffic in the traffic information corresponding to the updated VM scale-in preparation. The load balancer control unit 105 then calculates the number of the virtual machines 300 to be reduced from the decreased traffic. Next, the virtual machine control unit 106 selects the calculated number of the virtual machines 300 from the virtual machines 300 in operation, and determines the virtual machines 300 to be reduced. Next, the virtual machine control unit 106 notifies the load balancer 200 of the virtual machines 300 to be reduced. After that, the virtual machine control unit 106 stores the virtual machines 300 to be reduced to the VM pool. The load balancer control unit 105 and the virtual machine control unit 106 correspond to an example of “a control unit”.

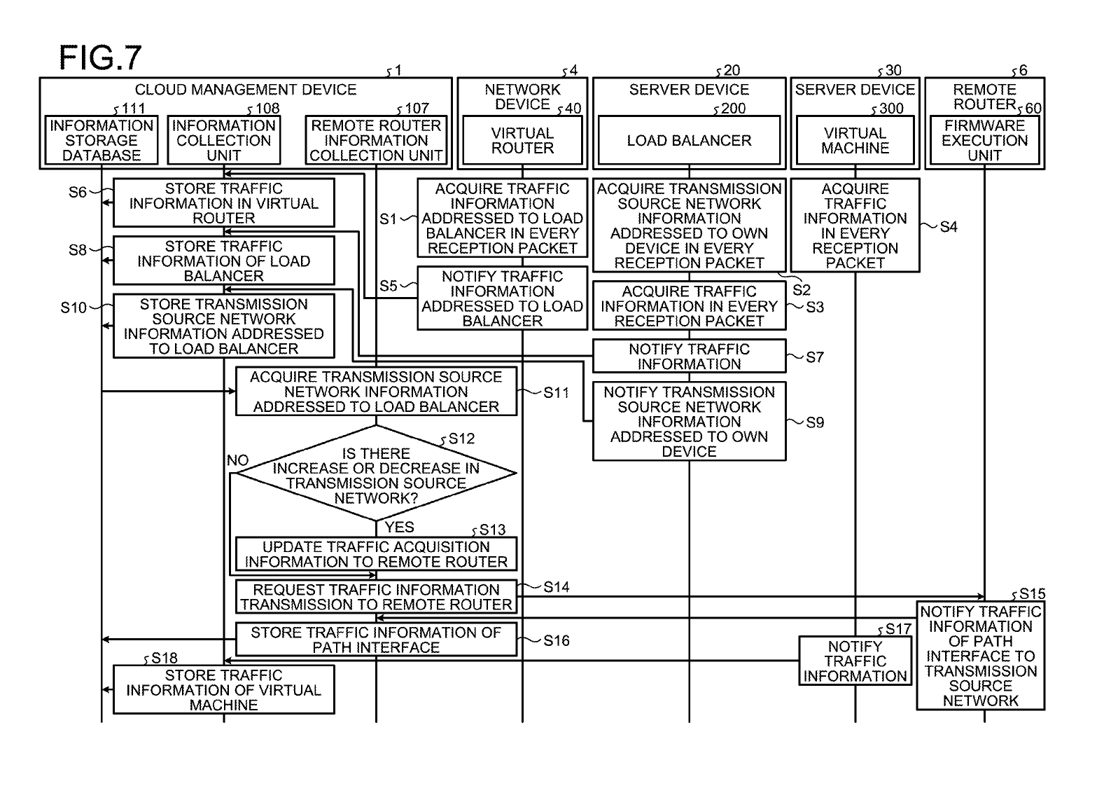

Next, a flow of information collection processing by the cloud management device 1 will be described with reference to FIG. 7. FIG. 7 is a sequence diagram of information collection processing by a cloud management device. In FIG. 7, the arrows connecting the devices represent flows of data and notifications of information. Further, other arrows in FIG. 7 represent flows of the processing. Here, a case in which a firmware execution unit 60 that executes firmware is operated in the remote router 6 will be described.

The virtual router 40 of the network device 4 acquires the traffic information addressed to the load balancer 200 in every transmission packet (Step S1).

The load balancer 200 of the server device 20 acquires the transmission source network information addressed to the own device in every reception packet (Step S2). Further, the load balancer 200 acquires the traffic information in every reception packet (Step S3).

The virtual machine 300 of the server device 30 acquires the traffic information after the reception packet (Step S4).

The virtual router 40 then notifies the traffic information addressed to the load balancer 200 to the information collection unit 108 of the cloud management device 1 (Step S5).

The information collection unit 108 acquires the traffic information addressed to the load balancer 200 from the virtual router 40. The information collection unit 108 then stores the traffic information addressed to the load balancer 200 to the information storage database 111 (Step S6).

Further, the load balancer 200 notifies the traffic information to the information collection unit 108 of the cloud management device 1 (Step S7).

The information collection unit 108 acquires the traffic information of the load balancer 200 from the load balancer 200. The information collection unit 108 then stores the traffic information of the load balancer 200 to the information storage database 111 (Step S8).

Further, the load balancer 200 notifies the transmission source network information of a packet addressed to the own device to the information collection unit 108 of the cloud management device 1 (Step S9).

The information collection unit 108 acquires the transmission source network information of a packet addressed to the load balancer 200 from the load balancer 200. The information collection unit 108 then stores the transmission source network information of a packet addressed to the load balancer 200 to the information storage database 111 (Step S10).

The remote router information collection unit 107 acquires the transmission source network information addressed to the load balancer 200 from the information storage database 111 (Step S11). The remote router information collection unit 107 then determines existence or non-existence of increase or decrease in the transmission source network (Step S12). In a case where the transmission source network is not increased or decreased (Step S12: No), the remote router information collection unit 107 proceeds to Step S14.

On the other hand, in a case where the transmission source network is increased or decreased (Step S12: Yes), the remote router information collection unit 107 identifies the path interface of the transmission source network of the remote router 6. The remote router information collection unit 107 then updates the traffic acquisition information to the remote router 6, using the identified path interface (Step S13).

Next, the remote router information collection unit 107 transmits the traffic acquisition information to the remote router 6 to send a traffic information transmission request to the firmware execution unit 60 of the remote router 6 (Step S14).

The firmware execution unit 60 of the remote router 6 receives the traffic information transmission request including the traffic acquisition information from the information collection unit 108. Next, the firmware execution unit 60 collects the traffic information of the path interface specified in the traffic acquisition information. The firmware execution unit 60 then notifies the traffic information of the path interface to the transmission source network, to the remote router information collection unit 107 (Step S15).

The remote router information collection unit 107 acquires the traffic information of the path interface to the transmission source network from the firmware execution unit 60 of the remote router 6. The remote router information collection unit 107 then stores the traffic information of the path interface to the transmission source network, to the information storage database 111 (Step S16).

Further, the virtual machine 300 notifies the traffic information in the own machine to the information collection unit 108 (Step S17).

The information collection unit 108 acquires the traffic information from the virtual machine 300. The information collection unit 108 then stores the traffic information in the virtual machine 300 to the information storage database 111 (Step S18).

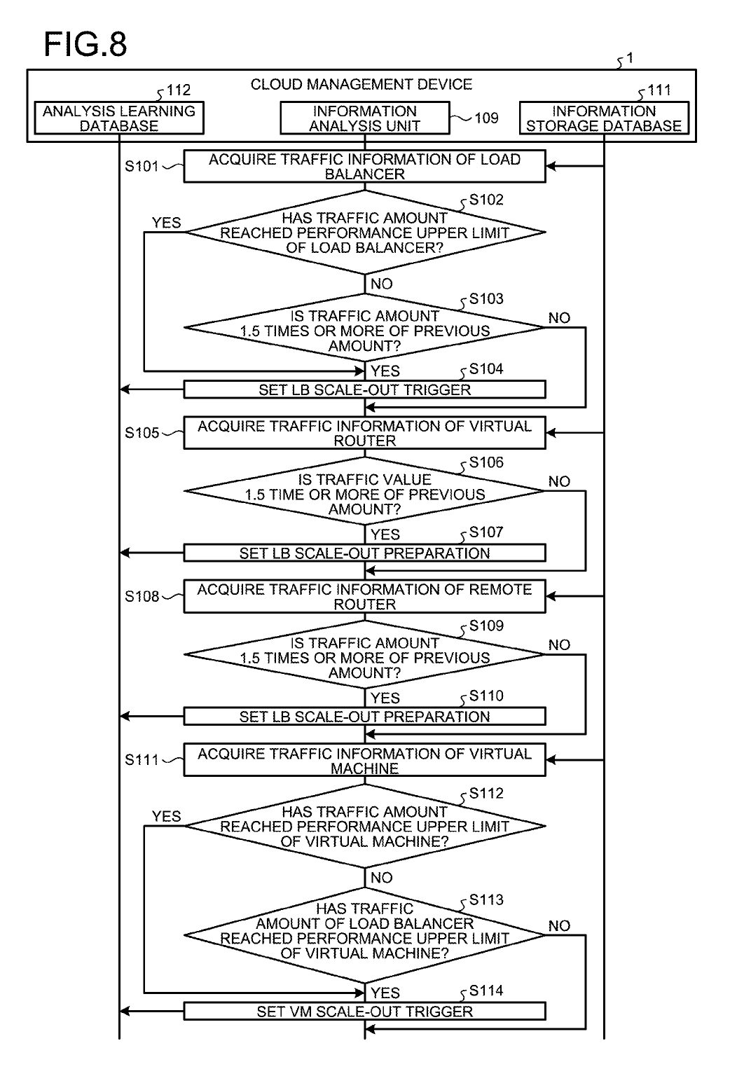

Next, a flow of information analysis processing regarding scale out by the cloud management device 1 according to the present embodiment will be described with reference to FIG. 8. FIG. 8 is a sequence diagram of information analysis processing regarding scale out by a cloud management device according to the first embodiment.

The information analysis unit 109 acquires the traffic information of the load balancer 200 from the information storage database 111 (Step S101). To be specific, the information analysis unit 109 acquires a total value of the traffic amounts of the load balancers 200.

Next, the information analysis unit 109 determines whether the traffic amount of the load balancer 200 has reached the performance upper limit of the load balancer 200 (Step S102). In a case where the traffic amount of the load balancer 200 has reached the performance upper limit of the load balancer 200 (Step S102: Yes), the information analysis unit 109 proceeds to Step S104.

Meanwhile, in a case where the traffic amount has not reached the performance upper limit of the load balancer 200 (Step S102: No), the information analysis unit 109 determines whether the traffic amount of the load balancer 200 is 1.5 times or more of the previously measured traffic amount (Step S103). In a case where the traffic amount is less than 1.5 times the previous traffic amount (Step S103: No), the information analysis unit 109 proceeds to Step S105.

In contrast, in a case where the traffic amount is 1.5 times or more of the previous traffic amount (Step S103: Yes), the information analysis unit 109 sets the LB scale-out trigger to the analysis learning database 112 (Step S104).

Next, the information analysis unit 109 acquires the traffic information of the virtual router 40 from the information storage database 111 (Step S105). To be specific, the information analysis unit 109 acquires a total value of the traffic amounts addressed to the load balancer 200, in the virtual router 40.

Next, the information analysis unit 109 determines whether the traffic amount of the virtual router 40 is 1.5 times or more of the previously measured traffic amount (Step S106). In a case where the traffic amount is less than 1.5 times the previous traffic amount (Step S106: No), the information analysis unit 109 proceeds to Step S108.

In contrast, in a case where the traffic amount is 1.5 times or more of the previous traffic amount (Step S106: Yes), the information analysis unit 109 sets the LB scale-out preparation to the analysis learning database 112 (Step S107).

Next, the information analysis unit 109 acquires the traffic information of the remote router 6 from the information storage database 111 (Step S108). To be specific, the information analysis unit 109 acquires the traffic information of the path interface of the remote router 6.

Next, the information analysis unit 109 determines whether the traffic amount of the remote router 6 is 1.5 times or more of the previously measured traffic amount (Step S109). In a case where the traffic amount is less than 1.5 times the previous traffic amount (Step S109: No), the information analysis unit 109 proceeds to Step S111.

In contrast, in a case where the traffic amount is 1.5 times or more of the previous traffic amount (Step S109: Yes), the information analysis unit 109 sets the LB scale-out preparation to the analysis learning database 112 (Step S110).

Next, the information analysis unit 109 acquires the traffic information of the virtual machine 300 from the information storage database 111 (Step S111). To be specific, the information analysis unit 109 acquires a total value of the traffic amounts of the virtual machines 300 registered in the load balancer 200.

Next, the information analysis unit 109 determines whether the traffic amount of the virtual machine 300 has reached the performance upper limit of the virtual machine 300 (Step S112). In a case where the traffic amount of the virtual machine 300 has reached the performance upper limit of the virtual machine 300 (Step S112: Yes), the information analysis unit 109 proceeds to Step S114.

Meanwhile, in a case where the traffic amount of the virtual machine 300 has not reached the performance upper limit of the virtual machine 300 (Step S112: No), the information analysis unit 109 determines whether the traffic amount of the load balancer 200 has reached the performance upper limit of the virtual machine 300 (Step S113).

In a case where the traffic amount of the load balancer 200 has reached the performance upper limit of the virtual machine 300 (Step S113: Yes), the information analysis unit 109 proceeds to Step S114.

Next, the information analysis unit 109 sets the VM scale-out trigger to the analysis learning database 112 (Step S114).

In contrast, in a case where the traffic amount of the load balancer 200 has not reached the performance upper limit of the virtual machine 300 (Step S113: No), the information analysis unit 109 terminates the information analysis processing.

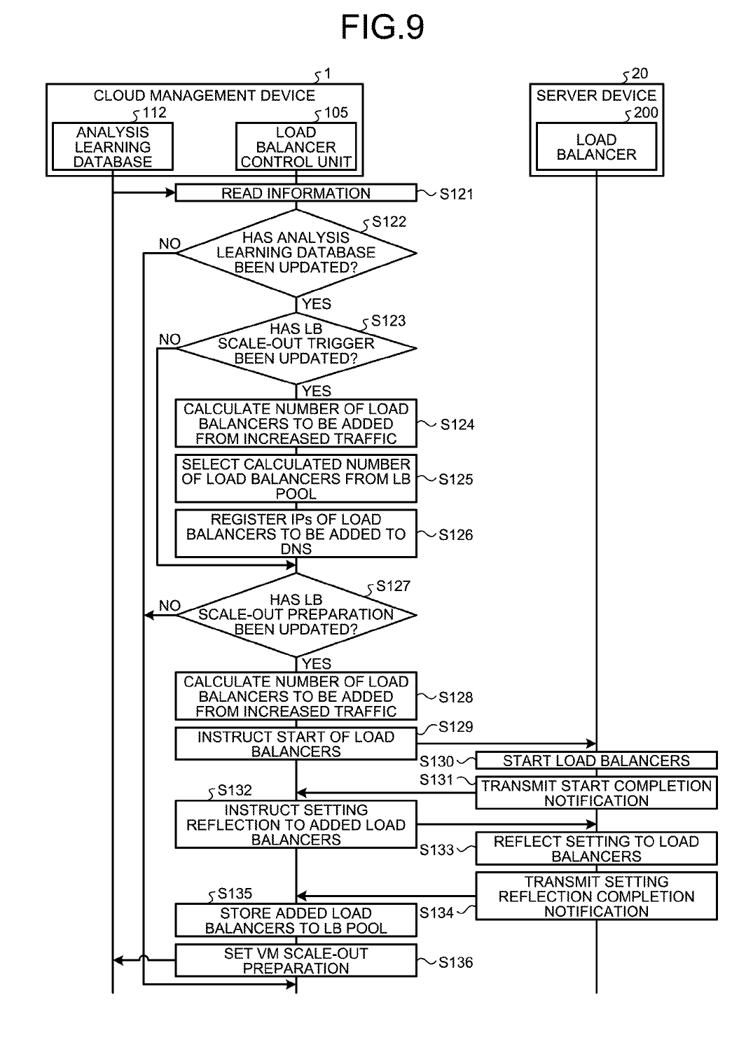

Next, a flow of scale-out processing of the load balancer 200 by the cloud management device 1 according to the present embodiment will be described with reference to FIG. 9. FIG. 9 is a sequence diagram of scale-out processing of a load balancer by the cloud management device according to the first embodiment.

The load balancer control unit 105 reads the information of the analysis learning database 112 (Step S121).

Next, the load balancer control unit 105 determines whether the analysis learning database 112 has been updated (Step S122). In a case where the analysis learning database 112 has not been updated (Step S122: No), the load balancer control unit 105 terminates the scale-out processing.

In contrast, in a case where the analysis learning database 112 has been updated (Step S122: Yes), the load balancer control unit 105 determines whether the LB scale-out trigger has been updated (Step S123). In a case where the LB scale-out trigger has not been updated (Step S123: No), the load balancer control unit 105 proceeds to Step S127.

In contrast, in a case where the LB scale-out trigger has been updated (Step S123: Yes), the load balancer control unit 105 calculates the number of the load balancers 200 to be added from the increased traffic (Step S124).

Next, the load balancer control unit 105 selects the calculated number of the load balancers 200 from the LB pool, and determines the selected load balancers 200 as the load balancers 200 to be added (Step S125).

The load balancer control unit 105 then registers the IPs of the load balancers 200 to be added to the DNS device 7 (Step S126).

Next, the load balancer control unit 105 determines whether the LB scale-out preparation has been updated (Step S127). In a case where the LB scale-out preparation has not been updated (Step S127: No), the load balancer control unit 105 terminates the scale-out processing.

In contrast, in a case where the LB scale-out preparation has been updated (Step S127: Yes), the load balancer control unit 105 calculates the number of the load balancers 200 to be added from the increased traffic in the traffic information corresponding to the updated LB scale-out preparation (Step S128).

Next, the load balancer control unit 105 instructs the server device 20 to start the calculated number of the load balancers 200 (Step S129).

The server device 20 starts the specified number of the load balancers 200 (Step S130) upon reception of the instruction of start of the load balancers 200.

After the start of the load balancers 200, the server device 20 transmits the start completion notification to the load balancer control unit 105 (Step S131).

Upon reception of the start completion notification, the load balancer control unit 105 instructs the server device 20 to reflect the setting to the added load balancers 200 (Step S132).

The server device 20 reflects the specified setting to the added load balancers 200 (Step S133) upon reception of the setting reflection instruction to the load balancers 200.

When the setting reflection to the load balancers 200 has been completed, the server device 20 transmits the setting reflection completion notification to the load balancer control unit 105 (Step S134).

Upon reception of the setting reflection completion notification, the load balancer control unit 105 stores the added load balancers 200 to the LB pool (Step S135). The pool information storage unit 115 acquires information of the added load balancers 200 from the load balancer control unit 105, and registers the resource ID of the load balancer 200 in association with the specified LB pool.

Further, the load balancer control unit 105 sets the VM scale-out preparation to the analysis learning database 112 (Step S136).

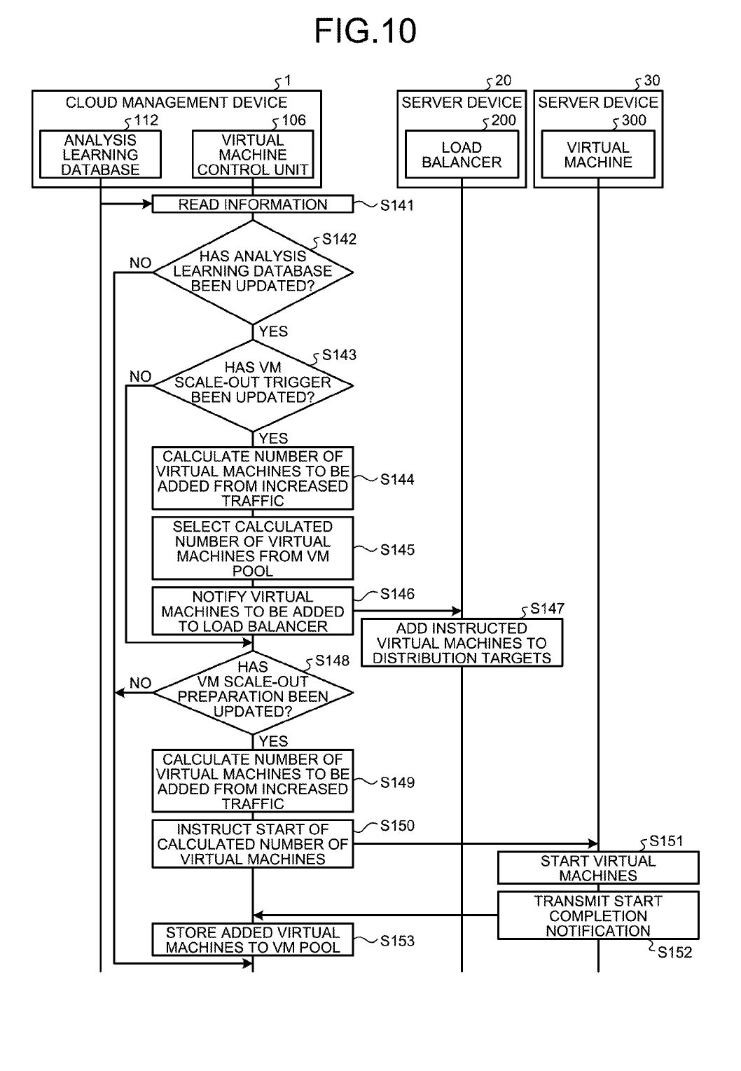

Next, a flow of scale-out processing of the virtual machine 300 by the cloud management device 1 according to the present embodiment will be described with reference to FIG. 10. FIG. 10 is a sequence diagram of scale-out processing of a virtual machine by the cloud management device according to the first embodiment.

The virtual machine control unit 106 reads the information of the analysis learning database 112 (Step S141).

Next, the virtual machine control unit 106 determines whether the analysis learning database 112 has been updated (Step S142). In a case where the analysis learning database 112 has not been updated (Step S142: No), the virtual machine control unit 106 terminates the scale-out processing.

In contrast, in a case where the analysis learning database 112 has been updated (Step S142: Yes), the virtual machine control unit 106 determines whether the VM scale-out trigger has been updated (Step S143). In a case where the VM scale-out trigger has not been updated (Step S143: No), the virtual machine control unit 106 proceeds to Step S148.

In contrast, in a case where the VM scale-out trigger has been updated (Step S143: Yes), the virtual machine control unit 106 calculates the increased traffic that is an increased amount of the traffic in the traffic information corresponding to the updated VM scale-out trigger. The virtual machine control unit 106 then calculates the number of the virtual machines 300 to be added from the increased traffic (Step S144).

Next, the virtual machine control unit 106 selects the calculated number of the virtual machines 300 from the VM pool, and determines the selected virtual machines 300 as the virtual machines 300 to be added (Step S145).

Next, the virtual machine control unit 106 notifies the virtual machines 300 to be added to the load balancer 200 (Step S146).

Upon reception of the notification of the virtual machines 300 to be added, the load balancer 200 adds the specified virtual machines 300 to distribution targets (Step S147).

Next, the virtual machine control unit 106 determines whether the VM scale-out preparation has been updated (Step S148).

In a case where the VM scale-out preparation has not been updated (Step S148: No), the load virtual machine control unit 106 terminates the scale-out processing.

In contrast, in a case where the VM scale-out preparation has been updated (Step S148: Yes), the virtual machine control unit 106 calculates the number of the virtual machines 300 to be added from the increased traffic in the traffic information corresponding to the updated VM scale-out preparation (Step S149).

Next, the virtual machine control unit 106 instructs the server device 30 to start the calculated number of the virtual machines 300 (Step S150).

The server device 30 starts the specified number of the virtual machines 300 (Step S151) upon reception of the instruction of start of the virtual machines 300.

After the start of the virtual machines 300, the server device 30 transmits the start completion notification to the virtual machine control unit 106 (Step S152).

Upon reception of the start completion notification, the virtual machine control unit 106 stores the added virtual machines 300 to the VM pool (Step S153). The pool information storage unit 115 acquires information of the added virtual machines 300 from the virtual machine control unit 106, and registers the resource ID of the specified virtual machine 300 in association with the specified VM pool.

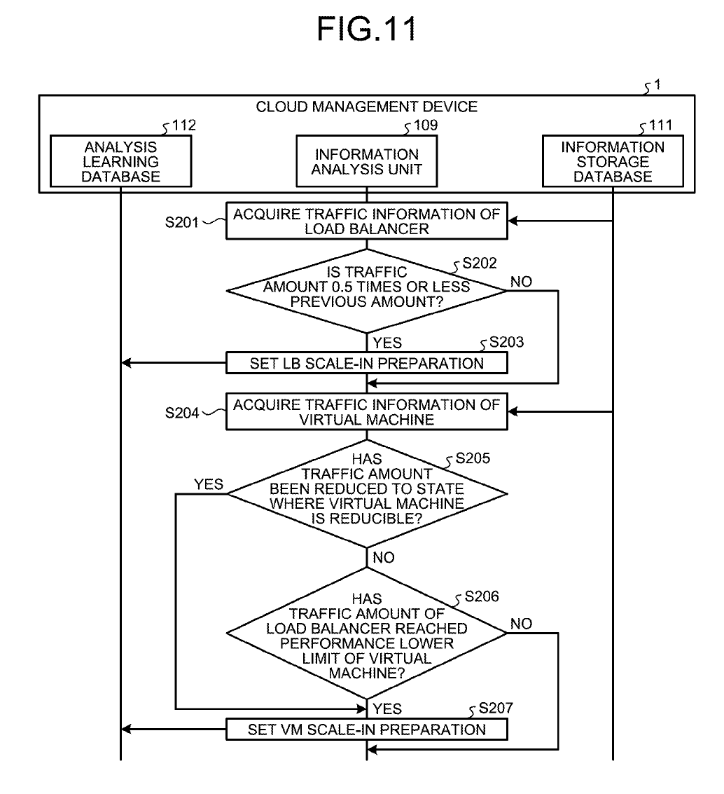

Next, a flow of information analysis processing regarding scale in by the cloud management device 1 according to the present embodiment will be described with reference to FIG. 11. FIG. 11 is a sequence diagram of information analysis processing regarding scale in by the cloud management device according to the first embodiment.

The information analysis unit 109 acquires the traffic information of the load balancer 200 from the information storage database 111 (Step S201). To be specific, the information analysis unit 109 acquires a total value of the traffic amounts of the load balancers 200.

Further, the information analysis unit 109 determines whether the traffic amount of the load balancer 200 is 0.5 times or less the previously measured traffic amount (Step S202). In a case where the traffic amount is larger than 0.5 times the previous traffic amount (Step S202: No), the information analysis unit 109 proceeds to Step S204.

In contrast, in a case where the traffic amount is 0.5 times or less the previous traffic amount (Step S202: Yes), the information analysis unit 109 sets the LB scale-in preparation to the analysis learning database 112 (Step S203).

Next, the information analysis unit 109 acquires the traffic information of the virtual machine 300 from the information storage database 111 (Step S204). To be specific, the information analysis unit 109 acquires a total value of the traffic amounts of the virtual machines 300 registered in the load balancer 200.

Next, the information analysis unit 109 determines whether the traffic amount of the virtual machine 300 has been reduced to a state where the virtual machine 300 is reducible (Step S205). In a case where the traffic amount of the virtual machine 300 has been reduced to the state where the virtual machine 300 is reducible (Step S205: Yes), the information analysis unit 109 proceeds to Step S207.

In contrast, in a case where the traffic amount has not been reduced to the state where the virtual machine 300 is reducible (Step S205: No), the information analysis unit 109 determines whether the traffic amount of the load balancer 200 has reached the performance lower limit of the virtual machine 300 (Step S206).

In a case where the traffic amount of the load balancer 200 has reached the performance lower limit of the virtual machine 300 (Step S206: Yes), the information analysis unit 109 proceeds to Step S207.

In a case where the traffic amount of the load balancer 200 has reached the performance lower limit of the virtual machine 300 or the traffic amount of the virtual machine 300 has been reduced to the state where the virtual machine 300 is reducible, the information analysis unit 109 sets the VM scale-in preparation to the analysis learning database 112 (Step S207).

In contrast, in a case where the traffic amount of the load balancer 200 has not reached the performance upper limit of the virtual machine 300 (Step S206: No), the information analysis unit 109 terminates the information analysis processing.

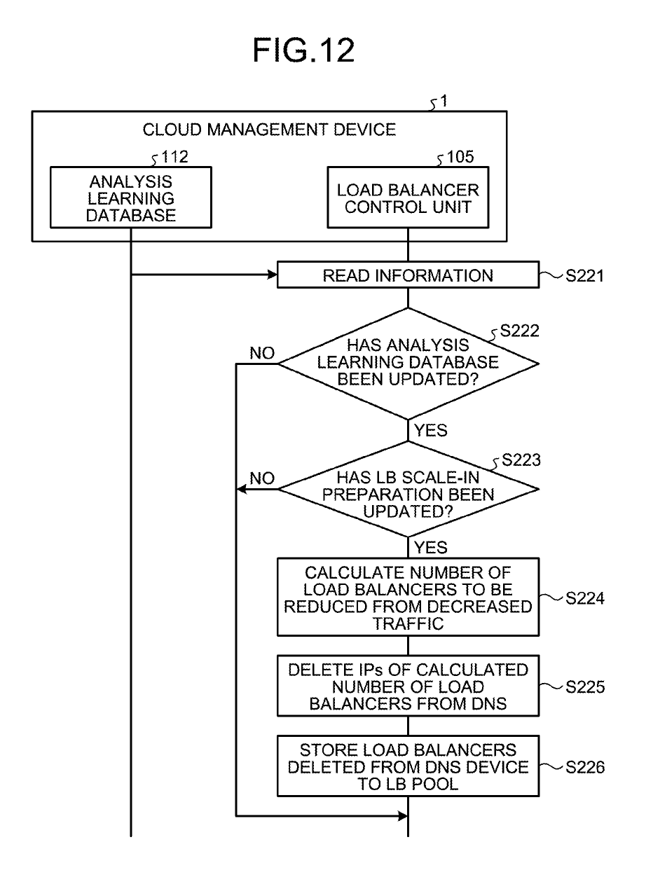

Next, a flow of scale-in processing of the load balancer 200 by the cloud management device 1 according to the present embodiment will be described with reference to FIG. 12. FIG. 12 is a sequence diagram of scale-in processing of the load balancer by the cloud management device according to the first embodiment.

The load balancer control unit 105 reads the information of the analysis learning database 112 (Step S221).

Next, the load balancer control unit 105 determines whether the analysis learning database 112 has been updated (Step S222). In a case where the analysis learning database 112 has not been updated (Step S222: No), the load balancer control unit 105 terminates the scale-in processing.

In contrast, in a case where the analysis learning database 112 has been updated (Step S222: Yes), the load balancer control unit 105 determines whether the LB scale-in preparation has been updated (Step S223). In a case where the LB scale-in preparation has not been updated (Step S223: No), the load balancer control unit 105 terminates the scale-in processing.

In contrast, in a case where the LB scale-in preparation has been updated (Step S223: Yes), the load balancer control unit 105 calculates the number of the load balancers 200 to be reduced from the decreased traffic that is a decreased amount of the traffic of the load balancer 200 (Step S224).

Next, the load balancer control unit 105 deletes the IPs of the calculated number of the load balancers 200 from the DNS device 7 (Step S225).

Next, the load balancer control unit 105 stores the load balancers 200 deleted from the DNS device 7 to the LB pool (Step S226).

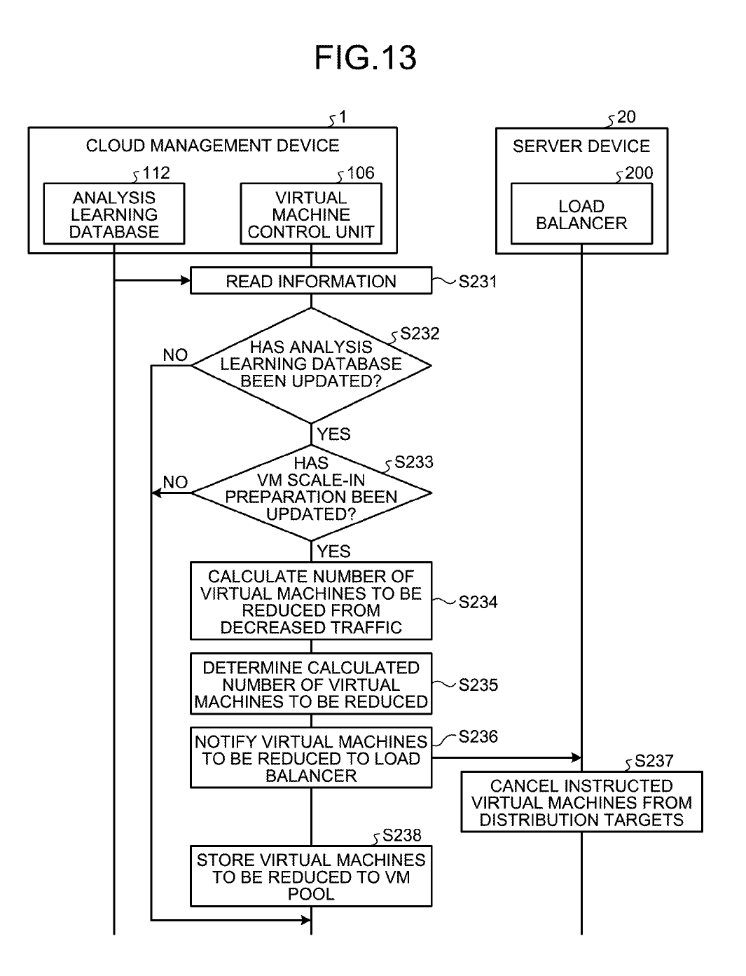

Next, a flow of scale-in processing of the virtual machine 300 by the cloud management device 1 according to the present embodiment will be described with reference to FIG. 13. FIG. 13 is a sequence diagram of scale-in processing of the virtual machine by the cloud management device according to the first embodiment.

The virtual machine control unit 106 reads the analysis learning database 112 (Step S231).

Next, the virtual machine control unit 106 determines whether the analysis learning database 112 has been updated (Step S232). In a case where the analysis learning database 112 has not been updated (Step S232: No), the virtual machine control unit 106 terminates the scale-in processing.

In contrast, in a case where the analysis learning database 112 has been updated (Step S232: Yes), the virtual machine control unit 106 determines whether the VM scale-in preparation has been updated (Step S233). In a case where the VM scale-in preparation has not been updated (Step S233: No), the load virtual machine control unit 106 terminates the scale-in processing.

In a case where the VM scale-in preparation has been updated (Step S233: Yes), the virtual machine control unit 106 calculates the decreased traffic that is a decreased amount of the traffic in the traffic information corresponding to the updated VM scale-in preparation. The virtual machine control unit 106 then calculates the number of the virtual machines 300 to be reduced from the decreased traffic (Step S234).

Next, the virtual machine control unit 106 selects the calculated number of the virtual machines 300 from the virtual machines 300 in operation, and determines the virtual machines 300 to be reduced (Step S235).

Next, the virtual machine control unit 106 notifies the virtual machines 300 to be reduced to the load balancer 200 (Step S236).

Upon reception of the notification of the virtual machines 300 to be reduced, the load balancer 200 cancels the specified virtual machines 300 from the distribution targets (Step S237).

Next, the virtual machine control unit 106 stores the virtual machines 300 to be reduced to the VM pool (Step S238).

Here, comparison between the cloud management device according to the present embodiment and another autoscale technology will be described. As description of another autoscale, in a case of using a method of forcibly deploying resources by an operation administrator, timing of the deployment is left to the operation administrator. For example, the operation administrator forcibly deploys the resources after recognizing a rapid increase in the traffic amount. That is, for the duration of the operation administrator's recognition of the increase in the traffic, the autoscale is not performed, and an over-performance state of the resources may occur. Therefore, it is difficult to perform appropriate autoscale according to change of the traffic amount.

Further, a method of performing autoscale in a case where abnormality occurs in resources in use has no relevance between the occurrence of the abnormality and the increase in the traffic amount. Therefore, it is difficult to appropriately handle the autoscale due to the increase in the traffic amount. Therefore, in a case where the traffic amount is increased, the over-performance state of the resources may occur, and it is difficult to perform appropriate autoscale according to change of the traffic amount.

Further, even if the conventional technology to arrange load balancers at front stages of servers in a cloud system is used, a conventional method is used as an autoscale method corresponding to an increase in the traffic amount, and it is difficult to decrease the over-performance state of the resources. Therefore, it is difficult to perform appropriate autoscale according to change of the traffic amount.

Further, even if the conventional technology to perform autoscale according to a result of load calculation of servers in a tree structure is used, a conventional method is used as an autoscale method corresponding to an increase in the traffic amount, and it is difficult to decrease the over-performance state of the resources. Therefore, it is difficult to perform appropriate autoscale according to change of the traffic amount.

Further, even if the conventional technology to obtain an influence range due to relevancy between business nodes is used, a conventional method is used as an autoscale method, and it is difficult to decrease the over-performance state of the resources.

In contrast, the cloud management system according to the present embodiment determines change of the traffic amount for the autoscale target resource, using the traffic amount of the resource arranged at a front stage of the autoscale target resource of which scale out is performed. Further, the cloud system using the cloud management device according to the present embodiment predicts increase or decrease in the traffic amount of the autoscale target resource, and prepares the resource to be used in the autoscale in advance. With the configuration, even if rapid variation in the traffic amount occurs, the autoscale is executed using the resource prepared in advance, and thus the autoscale can be completed in a short time. Therefore, even if a rapid variation in the traffic amount occurs, appropriate autoscale according to change of the traffic amount can be performed.

### [b] Second Embodiment

Next, a second embodiment will be described. A cloud management device 1 according to the present embodiment is also illustrated in the block diagram in FIG. 2. The cloud management device 1 according to the present embodiment is different from the first embodiment in learning periodic traffic change and executing autoscale according to the periodic traffic change in accordance with a learning result. In the description below, description of functions of units similar to those of the first embodiment is omitted.

The information analysis unit 109 acquires the traffic information of the load balancer 200 from the information storage database 111. To be specific, the information analysis unit 109 acquires a total value of the traffic amounts of the load balancers 200. Next, the information analysis unit 109 determines whether the traffic amount of the load balancer 200 has reached a performance upper limit of the load balancer 200. Further, the information analysis unit 109 determines whether the traffic amount of the load balancer 200 is 1.5 times or more of a previously measured traffic amount.

In a case where the traffic amount has reached the performance upper limit of the load balancer 200 or the traffic amount is 1.5 times or more of the previously measured traffic amount, the information analysis unit 109 performs periodicity determination processing below.

The information analysis unit 109 determines whether information of the same event type is stored in the same time zone in an analysis learning database 112. Here, the information analysis unit 109 considers events included within a predetermined range of time as events in the same time zone. In a case where the information of the same event type is stored in the same time zone, the information analysis unit 109 calculates an interval between the time of a previous event and the time of a current event. The information analysis unit 109 then determines a periodic change point type that indicates what interval the event occurs from the calculated interval.

For example, in the present embodiment, the information analysis unit 109 determines the periodic change point type as “hour”, in a case where the same event occurs one hour after the previous time. Further, the information analysis unit 109 determines the periodic change point type as “day”, in a case where the same event occurs one day after the previous time. Further, the information analysis unit 109 determines the periodic change point type as “week”, in a case where the same event occurs one week after the previous time. Further, the information analysis unit 109 determines the periodic change point type as “month”, in a case where the same event occurs one month after the previous time.

The information analysis unit 109 then increments a periodicity counter having the same periodic change point type in the same time zone in the analysis learning database 112. Further, the information analysis unit 109 newly registers information with a changed periodic change point type, in a case where there is no information of the same periodic change point type.

Next, the information analysis unit 109 determines whether the incremented periodicity counter indicates a threshold or more. In a case where the periodicity counter indicates the threshold or more, the information analysis unit 109 sets an entry having the incremented periodicity counter to a periodic change point for increase. The periodic change point for increase is a point to execute scale-out processing similar to the previous processing, in a case where the time of the point has come. The information analysis unit 109 sets the periodic change point for increase to the analysis learning database 112.

Further, in a case where the information of the same event type is not stored in the same time zone in the analysis learning database 112, the information analysis unit 109 newly registers basic information such as acquisition time and identification information of the traffic information to the analysis learning database 112. Further, the information analysis unit 109 sets an LB scale-out trigger to the registered entry.

Further, the information analysis unit 109 acquires the traffic information of the load balancer 200 from the information storage database 111. To be specific, the information analysis unit 109 acquires a total value of the traffic amounts of the load balancers 200. Next, the information analysis unit 109 determines whether the traffic amount of the load balancer 200 is 0.5 times or less the previously measured traffic amount.

In a case where the traffic amount is 0.5 times or less the previously measured traffic amount, the information analysis unit 109 performs periodicity determination processing below.

The information analysis unit 109 determines whether information of the same event type is stored in the same time zone in the analysis learning database 112. Here, the information analysis unit 109 considers events included within a predetermined range of time as events in the same time zone. In a case where the information of the same event type is stored in the same time zone, the information analysis unit 109 calculates an interval between the time of a previous event and the time of a current event. The information analysis unit 109 then determines the periodic change point type from the calculated interval.

The information analysis unit 109 then increments the periodicity counter having the same periodic change point type in the same time zone in the analysis learning database 112. Further, the information analysis unit 109 newly registers information with a changed periodic change point type, in a case where there is no information of the same periodic change point type.

Next, the information analysis unit 109 determines whether the incremented periodicity counter indicates a threshold or more. In a case where the periodicity counter indicates the threshold or more, the information analysis unit 109 sets an entry having the incremented periodicity counter to a periodic change point for decrease. The periodic change point for decrease is a point to execute scale-in processing similar to the previous processing, in a case where the time of the point has come. The information analysis unit 109 sets the periodic change point for decrease to the analysis learning database 112.

Further, in a case where the information of the same event type is not stored in the same time zone in the analysis learning database 112, the information analysis unit 109 newly registers basic information such as acquisition time and identification information of the traffic information to the analysis learning database 112. Further, the information analysis unit 109 sets LB scale-in preparation to the registered entry.

Further, the information analysis unit 109 acquires traffic information of a virtual machine 300 from the information storage database 111. To be specific, the information analysis unit 109 acquires a total value of the traffic amounts of the virtual machines 300 registered in the load balancer 200. Next, the information analysis unit 109 determines whether the traffic amount of the virtual machine 300 has reached a performance upper limit of the virtual machine 300. Further, the information analysis unit 109 determines whether the traffic amount of the load balancer 200 has reached the performance upper limit of the virtual machine 300.

In a case where the traffic amount of the virtual machine 300 has reached the performance upper limit of the virtual machine 300, or the traffic amount of the load balancer 200 has reached the performance upper limit of the virtual machine 300, the information analysis unit 109 performs periodicity determination processing below.

The information analysis unit 109 determines whether information of the same event type is stored in the same time zone in the analysis learning database 112. In a case where the information of the same event type is stored in the same time zone, the information analysis unit 109 calculates an interval between the time of a previous event and the time of a current event, and determines the periodic change point type. The information analysis unit 109 then increments the periodicity counter having the same periodic change point type in the same time zone in the analysis learning database 112. Further, the information analysis unit 109 newly registers information with a changed periodic change point type, in a case where there is no information of the same periodic change point type.

Next, the information analysis unit 109 determines whether the incremented periodicity counter indicates a threshold or more. In a case where the periodicity counter indicates the threshold or more, the information analysis unit 109 sets an entry having the incremented periodicity counter to a periodic change point for increase.

Meanwhile, in a case where the information of the same event type is not stored in the same time zone, the information analysis unit 109 newly registers basic information such as acquisition time and identification information of the traffic information to the analysis learning database 112. Further, the information analysis unit 109 sets the VM scale-out trigger to the registered entry.

Further, the information analysis unit 109 determines whether the traffic amount of the virtual machine 300 has been reduced to a state where the virtual machine 300 is reducible. Further, the information analysis unit 109 determines whether the traffic amount of the load balancer 200 has reached a performance lower limit of the virtual machine 300.

In a case where the traffic amount of the virtual machine 300 has been reduced to the state where the virtual machine 300 is reducible or the traffic amount of the load balancer 200 has reached the performance lower limit of the virtual machine 300, the information analysis unit 109 performs periodicity determination processing below.

The information analysis unit 109 determines whether information of the same event type is stored in the same time zone in the analysis learning database 112. In a case where the information of the same event type is stored in the same time zone, the information analysis unit 109 calculates an interval between the time of a previous event and the time of a current event, and determines the periodic change point type. The information analysis unit 109 then increments the periodicity counter having the same periodic change point type in the same time zone in the analysis learning database 112. Further, the information analysis unit 109 newly registers information with a changed periodic change point type, in a case where there is no information of the same periodic change point type.

Next, the information analysis unit 109 determines whether the incremented periodicity counter indicates a threshold or more. In a case where the periodicity counter indicates the threshold or more, the information analysis unit 109 sets an entry having the incremented periodicity counter to a periodic change point for decrease.

Meanwhile, in a case where the information of the same event type is not stored in the same time zone, the information analysis unit 109 newly registers basic information such as acquisition time and identification information of the traffic information to the analysis learning database 112. Further, the information analysis unit 109 sets VM scale-in preparation to the registered entry.

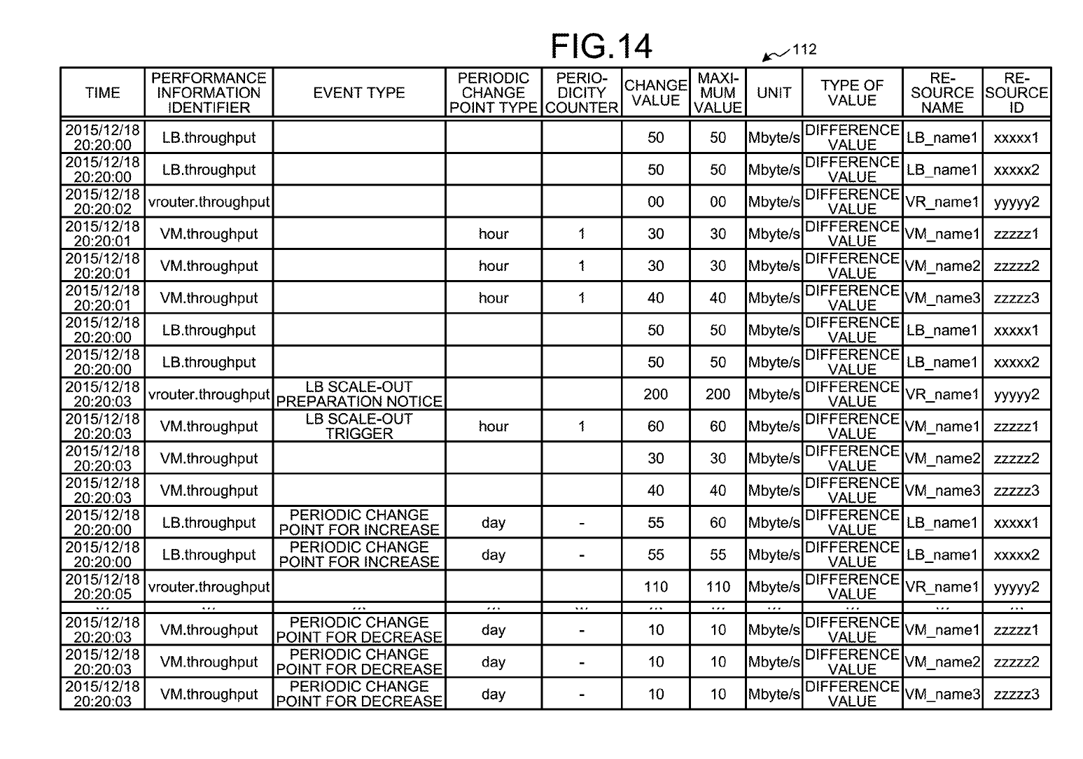

Here, the analysis learning database 112 according to the present embodiment will be described with reference to FIG. 14. FIG. 14 is a diagram illustrating an example of an analysis learning database according to the second embodiment.

As illustrated in FIG. 14, the analysis learning database 112 according to the present embodiment includes fields of the periodic change point type, the periodicity counter, and a maximum value. The periodic change point type indicates a type of periodic change by which an occurring event is classified according to an interval to occur. Further, the periodicity counter indicates the number of times of events occurring in the same time zone. The maximum value indicates a maximum value of when the events occurs at the same time.

A load balancer control unit 105 determines whether the time of the periodic change point for increase has come, in addition to a case where the LB scale-out trigger in the analysis learning database 112 has been updated. In a case where the time of the periodic change point for increase has come, in addition to in a case where the LB scale-out trigger has been updated, the load balancer control unit 105 performs scale out of the load balancer 200. In a case where the time of the periodic change point for increase has come, the load balancer control unit 105 acquires the maximum value of an increased traffic at the periodic change point for increase from the analysis learning database 112. The load balancer control unit 105 then calculates the number of the load balancers 200 to be added from the acquired maximum value. Next, the load balancer control unit 105 selects the calculated number of the load balancers 200 from an LB pool, and determines the selected load balancers 200 as the load balancers 200 to be added. The load balancer control unit 105 then registers IPs of the load balancers 200 to be added to a DNS device 7.

Further, the load balancer control unit 105 determines whether the time of the periodic change point for decrease for the load balancer 200 registered in the analysis learning database 112 has come. In a case where the time of the periodic change point for decrease has come, the load balancer control unit 105 calculates the number of the load balancers 200 to be reduced from a decreased traffic at the periodic change point for decrease. Next, the load balancer control unit 105 selects the calculated number of the load balancers 200 from the load balancers 200 in operation. Next, the load balancer control unit 105 deletes the IPs of the load balancers 200 from the DNS device 7. Next, the load balancer control unit 105 instructs a server device 20 to delete the selected load balancers 200.

Further, a decrease in the traffic amount of the load balancer 200 is expected, and a possibility of a decrease in the traffic amount of the virtual machine 300 corresponding to the decrease in the traffic amount of the load balancer 200 is high. Therefore, the load balancer control unit 105 sets VM scale-in preparation to the analysis learning database 112.

A virtual machine control unit 106 determines whether the time of the periodic change point for increase has come, in addition to a case where the VM scale-out trigger has been updated. Then, in a case where the time of the periodic change point for increase has come, in addition to a case where the VM scale-out trigger has been updated, the virtual machine control unit 106 performs scale out of the virtual machine 300. In a case where the time of the periodic change point for increase has come, the virtual machine control unit 106 acquires the maximum value of an increased traffic at the periodic change point for increase, which is an increased amount of the traffic at the periodic change point for increase, from the analysis learning database 112. The virtual machine control unit 106 then calculates the number of the virtual machines 300 to be added from the acquired maximum value. Next, the virtual machine control unit 106 selects the calculated number of the virtual machines 300 from a VM pool, and determines the selected virtual machines 300 as the virtual machines 300 to be added. The virtual machine control unit 106 then notifies the load balancer 200 of the virtual machines 300 to be added.

Further, the virtual machine control unit 106 determines whether the time of the periodic change point for decrease for the virtual machine 300 registered in the analysis learning database 112 has come. In a case where the time of the periodic change point for decrease has come, the virtual machine control unit 106 calculates decreased traffic that is a decreased amount of the traffic at the periodic change point for decrease. The virtual machine control unit 106 then calculates the number of the virtual machines 300 to be reduced from the decreased traffic. Next, the virtual machine control unit 106 selects the calculated number of the virtual machines 300 from the virtual machines 300 in operation, and determines the virtual machines 300 to be reduced. Next, the virtual machine control unit 106 notifies the load balancer 200 of the virtual machines 300 to be reduced. Next, the virtual machine control unit 106 instructs a server device 30 to delete the selected number of the virtual machines 300.

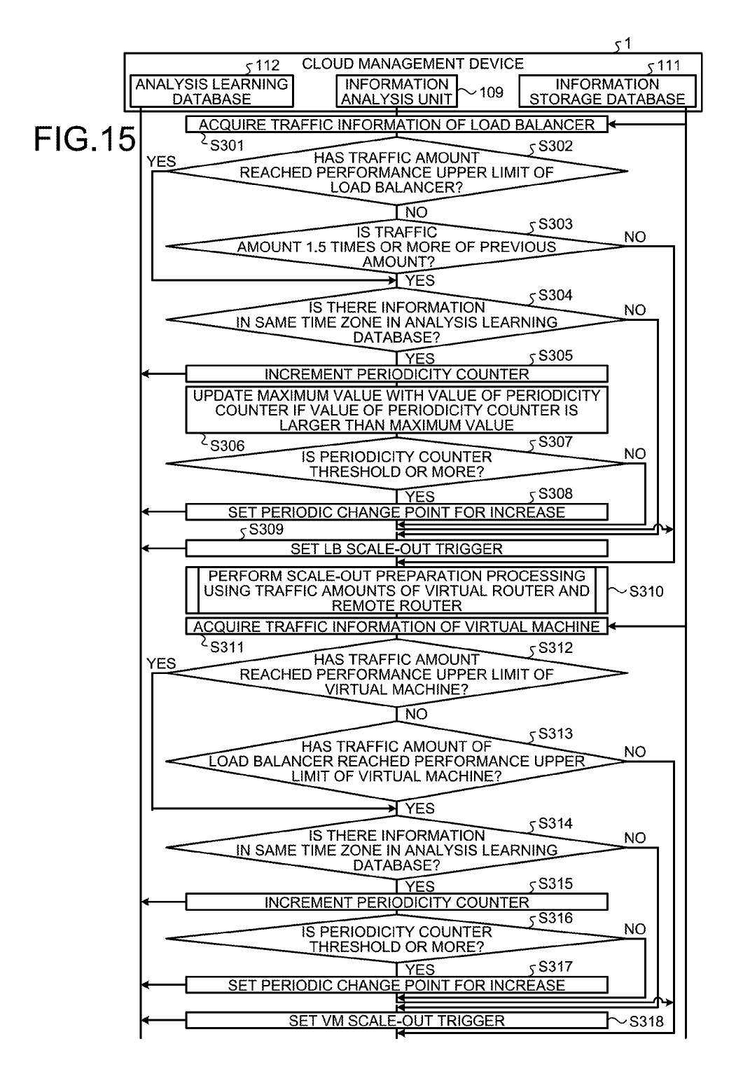

Next, a flow of information analysis processing regarding scale out by the cloud management device 1 according to the present embodiment will be described with reference to FIG. 15. FIG. 15 is a sequence diagram of information analysis processing regarding scale out by a cloud management device according to the second embodiment.

The information analysis unit 109 acquires the traffic information of the load balancer 200 from the information storage database 111 (Step S301). To be specific, the information analysis unit 109 acquires a total value of the traffic amounts of the load balancers 200.

Next, the information analysis unit 109 determines whether the traffic amount of the load balancer 200 has reached the performance upper limit of the load balancer 200 (Step S302). In a case where the traffic amount of the load balancer 200 has reached the performance upper limit of the load balancer 200 (Step S302: Yes), the information analysis unit 109 proceeds to Step S304.

Meanwhile, in a case where the traffic amount has not reached the performance upper limit of the load balancer 200 (Step S302: No), the information analysis unit 109 determines whether the traffic amount of the load balancer 200 is 1.5 times or more of the previously measured traffic amount (Step S303). In a case where the traffic amount is less than 1.5 times the previous traffic amount (Step S303: No), the information analysis unit 109 proceeds to Step S310.

In contrast, in a case where the traffic amount is 1.5 times or more of the previous traffic amount (Step S303: Yes), the information analysis unit 109 proceeds to Step S304.

Next, the information analysis unit 109 determines whether the information of the same event type is stored in the same time zone in the analysis learning database 112 (Step S304). In a case where the information of the same event type is not stored in the same time zone (Step S304: No), the information analysis unit 109 proceeds to Step S309.

In contrast, in a case where the information of the same event type is stored in the same time zone (Step S304: Yes), the information analysis unit 109 calculates the interval between the time of the previous event and the time of the current event, and determines the periodic change point type. The information analysis unit 109 then increments the periodicity counter having the same periodic change point type in the same time zone in the analysis learning database 112 (Step S305).

Further, the information analysis unit 109 confirms the maximum value of the events of the incremented periodicity counter. In a case where the value of the periodicity counter is larger than the maximum value, the information analysis unit 109 updates the maximum value with the value of the periodicity counter (Step S306).

Next, the information analysis unit 109 determines whether the incremented periodicity counter indicates a threshold or more (Step S307). In a case where the periodicity counter indicates less than the threshold (Step S307: No), the information analysis unit 109 proceeds to Step S310.

In contrast, in a case where the periodicity counter indicates the threshold or more (Step S307: Yes), the information analysis unit 109 sets an entry having the incremented periodicity counter to the periodic change point for increase (Step S308) and proceeds to Step S310.

Further, in a case where the information of the same event type is not stored in the same time zone, the information analysis unit 109 sets the LB scale-out trigger to the analysis learning database 112 (Step S309).

Next, the information analysis unit 109 executes processing of setting scale-out preparation, using traffic amounts of a virtual router 40 and a remote router 6 (Step S310). Here, Steps S105 to S110 in FIG. 8 correspond to an example of processing executed in Step S310.

Next, the information analysis unit 109 acquires the traffic information of the virtual machine 300 from the information storage database 111 (Step S311). To be specific, the information analysis unit 109 acquires a total value of the traffic amounts of the virtual machines 300 registered in the load balancer 200.

Next, the information analysis unit 109 determines whether the traffic amount of the virtual machine 300 has reached the performance upper limit of the virtual machine 300 (Step S312). In a case where the traffic amount of the virtual machine 300 has reached the performance upper limit of the virtual machine 300 (Step S312: Yes), the information analysis unit 109 proceeds to Step S314.

Meanwhile, in a case where the traffic amount of the virtual machine 300 has not reached the performance upper limit of the virtual machine 300 (Step S312: No), the information analysis unit 109 determines whether the traffic amount of the load balancer 200 has reached the performance upper limit of the virtual machine 300 (Step S313).

In a case where the traffic amount of the load balancer 200 has not reached the performance upper limit of the virtual machine 300 (Step S313: No), the information analysis unit 109 terminates the information analysis processing.

In contrast, in a case where the traffic amount of the load balancer 200 has reached the performance upper limit of the virtual machine 300 (Step S313: Yes), the information analysis unit 109 proceeds to Step S314.

The information analysis unit 109 then determines whether the information of the same event type is stored in the same time zone in the analysis learning database 112 (Step S314). In a case where the information of the same event type is stored in the same time zone (Step S314: Yes), the information analysis unit 109 calculates the interval between the time of the previous event and the time of the current event, and determines the periodic change point type. The information analysis unit 109 then increments the periodicity counter having the same periodic change point type in the same time zone in the analysis learning database 112 (Step S315).

Next, the information analysis unit 109 determines whether the incremented periodicity counter indicates a threshold or more (Step S316). In a case where the periodicity counter indicates less than the threshold (Step S316: No), the information analysis unit 109 terminates the information analysis processing.

In contrast, in a case where the periodicity counter indicates the threshold or more (Step S316: Yes), the information analysis unit 109 sets the entry having the incremented periodicity counter to the periodic change point for increase (Step S317) and terminates the information analysis processing.

Meanwhile, in a case where the information of the same event type is not stored in the same time zone (Step S314: No), the information analysis unit 109 sets the VM scale-out trigger to the analysis learning database 112 (Step S318).

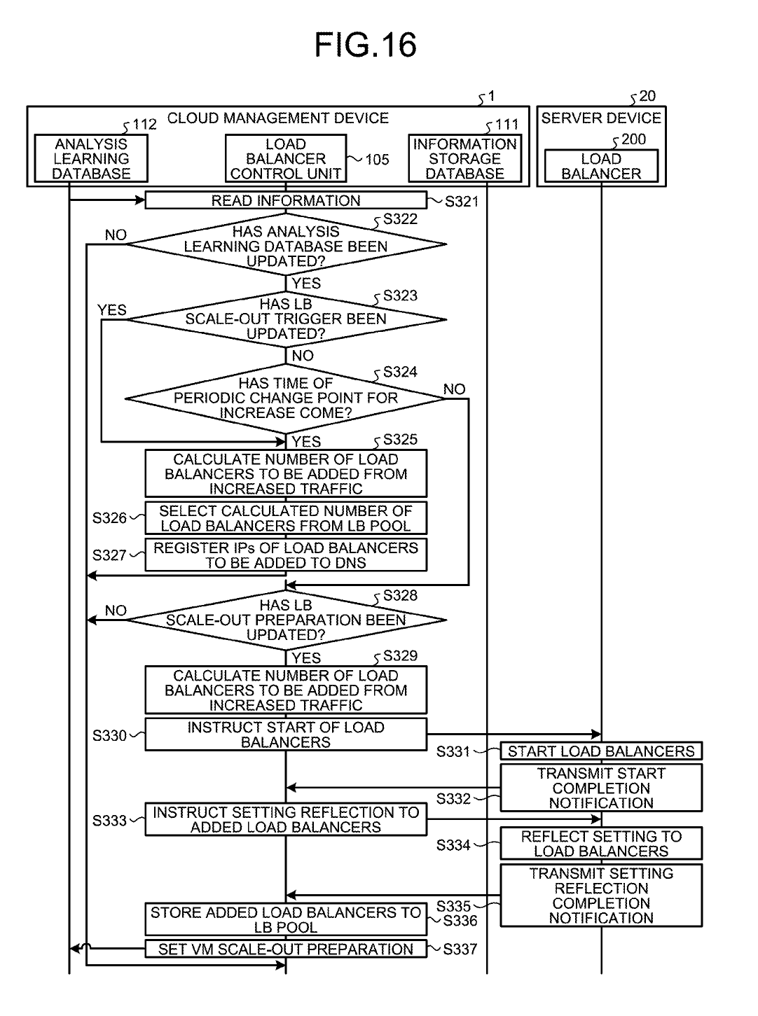

Next, a flow of scale-out processing of the load balancer 200 by the cloud management device 1 according to the present embodiment will be described with reference to FIG. 16. FIG. 16 is a sequence diagram of scale-out processing of a load balancer by the cloud management device according to the second embodiment.

The load balancer control unit 105 reads the information of the analysis learning database 112 (Step S321).

Next, the load balancer control unit 105 determines whether the analysis learning database 112 has been updated (Step S322). In a case where the analysis learning database 112 has not been updated (Step S322: No), the load balancer control unit 105 terminates the scale-out processing.

In contrast, in a case where the analysis learning database 112 has been updated (Step S322: Yes), the load balancer control unit 105 determines whether the LB scale-out trigger has been updated (Step S323). In a case where the LB scale-out trigger has been updated (Step S323: Yes), the load balancer control unit 105 proceeds to Step S325.

In contrast, in a case where the LB scale-out trigger has not been updated (Step S323: No), the load balancer control unit 105 determines whether the time of the periodic change point for increase has come (Step S324). In a case where the time of the periodic change point for increase has not come (Step S324: No), the load balancer control unit 105 proceeds to Step S328.

In contrast, in a case where the time of the periodic change point for increase has come (Step S324: Yes) the load balancer control unit 105 proceeds to Step S325.

The load balancer control unit 105 then acquires the maximum value of the increased traffic at the periodic change point for increase from the analysis learning database 112. The load balancer control unit 105 then calculates the number of the load balancers 200 to be added from the increased traffic of the acquired maximum value (Step S325).

Next, the load balancer control unit 105 selects the calculated number of the load balancers 200 from the LB pool, and determines the selected load balancers 200 as the load balancers 200 to be added (Step S326). Here, in a case where the load balancer 200 is insufficient in the LB pool, the load balancer control unit 105 instructs the server device 20 to start the insufficient number of the load balancers 200. The load balancers 200 started by the server device 20 are added to the LB pool. After that, the load balancer control unit 105 executes the processing of Step S326.

The load balancer control unit 105 then registers the IPs of the load balancers 200 to be added to the DNS device 7, and terminates the scale-out processing (Step S327).

Meanwhile, in a case where the LB scale-out trigger has not been updated, and the time of the periodic change point for increase has not come, the load balancer control unit 105 determines whether the LB scale-out preparation has been updated (Step S328). In a case where the LB scale-out preparation has not been updated (Step S328: No), the load balancer control unit 105 terminates the scale-out processing.

In contrast, in a case where the LB scale-out preparation has been updated (Step S328: Yes), the load balancer control unit 105 calculates the number of the load balancers 200 to be added from the increased traffic in the traffic information corresponding to the updated LB scale-out preparation (Step S329).

Next, the load balancer control unit 105 instructs the server device 20 to start the calculated number of the load balancers 200 (Step S330).

The server device 20 starts the specified number of the load balancers 200 (Step S331) upon reception of the instruction of start of the load balancers 200.

After the start of the load balancers 200, the server device 20 transmits a start completion notification to the load balancer control unit 105 (Step S332).

Upon reception of the start completion notification, the load balancer control unit 105 instructs the server device 20 to reflect the setting to the added load balancers 200 (Step S333).

The server device 20 reflects the specified setting to the added load balancers 200 (Step S334) upon reception of the setting reflection instruction to the load balancers 200.

When the setting reflection to the load balancers 200 has been completed, the server device 20 transmits a setting reflection completion notification to the load balancer control unit 105 (Step S335).

Upon reception of the setting reflection completion notification, the load balancer control unit 105 stores the added load balancers 200 to the LB pool (Step S336).

Further, the load balancer control unit 105 sets the VM scale-out preparation to the analysis learning database 112 (Step S337).

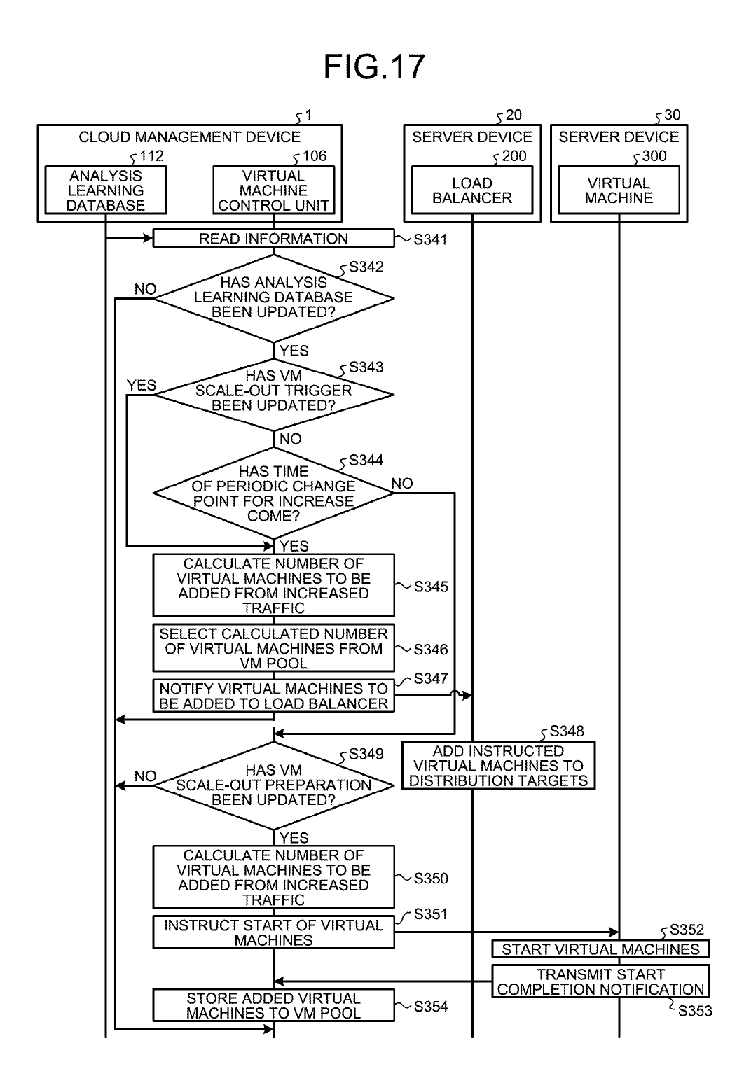

Next, a flow of scale-out processing of the virtual machine 300 by the cloud management device 1 according to the present embodiment will be described with reference to FIG. 17. FIG. 17 is a sequence diagram of scale-out processing of a virtual machine by the cloud management system according to the second embodiment.

The virtual machine control unit 106 reads the analysis learning database 112 (Step S341).

Next, the virtual machine control unit 106 determines whether the analysis learning database 112 has been updated (Step S342). In a case where the analysis learning database 112 has not been updated (Step S342: No), the virtual machine control unit 106 terminates the scale-out processing.

In contrast, in a case where the analysis learning database 112 has been updated (Step S342: Yes), the virtual machine control unit 106 determines whether the VM scale-out trigger has been updated (Step S343). In a case where the VM scale-out trigger has been updated (Step S343: Yes), the virtual machine control unit 106 proceeds to Step S345.

In contrast, in a case where the VM scale-out trigger has not been updated (Step S343: No), the virtual machine control unit 106 determines whether the time of the periodic change point for increase has come (Step S344). In a case where the time of the periodic change point for increase has not come (Step S344: No), the virtual machine control unit 106 proceeds to Step S349.

In contrast, in a case where the time of the periodic change point for increase has come (Step S344: Yes), the virtual machine control unit 106 acquires the maximum value of the increased traffic at the periodic change point for increase from the analysis learning database 112. The virtual machine control unit 106 then calculates the number of the virtual machines 300 to be added from the increased traffic of the acquired maximum value (Step S345).

Next, the virtual machine control unit 106 selects the calculated number of the virtual machines 300 from the VM pool, and determines the selected virtual machines 300 as the virtual machines 300 to be added (Step S346). Here, when the virtual machine 300 is insufficient in the VM pool, the virtual machine control unit 106 instructs the server device 30 to start the insufficient number of the virtual machines 300. The virtual machines 300 started by the server device 30 are added to the VM pool. After that, the virtual machine control unit 106 executes the processing of Step S346.

Next, the virtual machine control unit 106 notifies the virtual machines 300 to be added to the load balancer 200 (Step S347).

Upon reception of the notification of the virtual machines 300 to be added, the load balancer 200 adds the specified virtual machines 300 to distribution targets (Step S348).

Next, the virtual machine control unit 106 determines whether the VM scale-out preparation has been updated (Step S349).

In a case where the VM scale-out preparation has not been updated (Step S349: No), the load virtual machine control unit 106 terminates the scale-out processing.

In contrast, in a case where the VM scale-out preparation has been updated (Step S349: Yes), the virtual machine control unit 106 calculates the number of the virtual machines 300 to be added from the increased traffic in the traffic information corresponding to the updated VM scale-out preparation (Step S350).

Next, the virtual machine control unit 106 instructs the server device 30 to start the calculated number of the virtual machines 300 (Step S351).

The server device 30 starts the specified number of the virtual machines 300 (Step S352) upon reception of the instruction of start of the virtual machines 300.

After the start of the virtual machines 300, the server device 30 transmits the start completion notification to the virtual machine control unit 106 (Step S353).

Upon reception of the start completion notification, the virtual machine control unit 106 stores the added virtual machines 300 to the VM pool (Step S354).

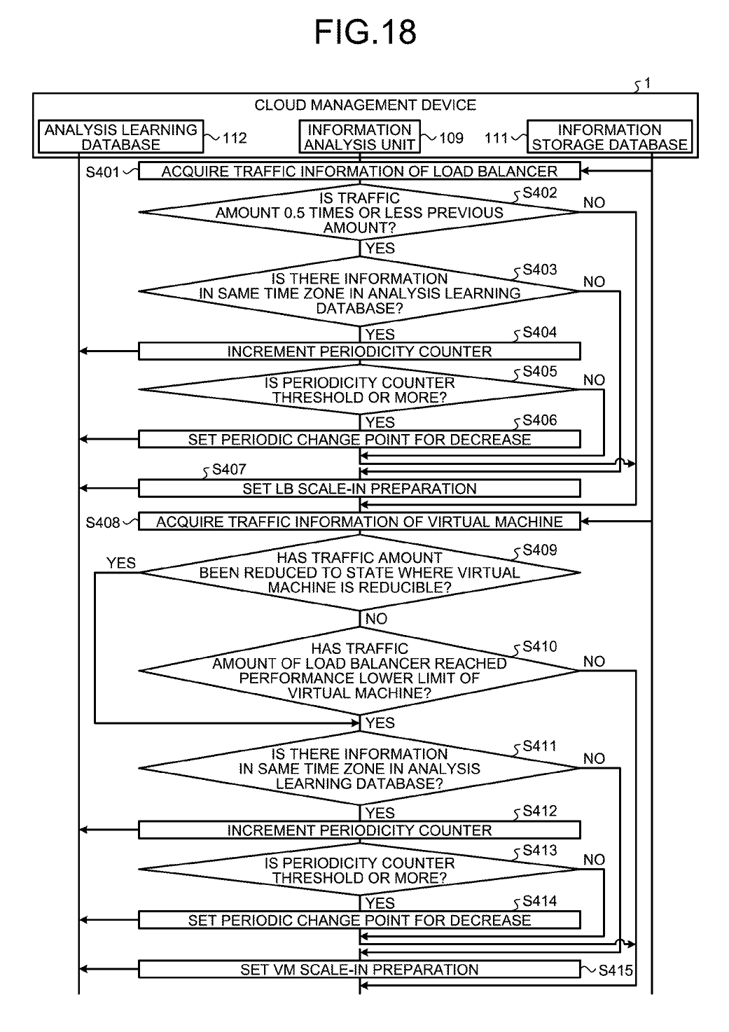

Next, a flow of information analysis processing regarding scale in by the cloud management device 1 according to the present embodiment will be described with reference to FIG. 18. FIG. 18 is a sequence diagram of information analysis processing regarding scale in by the cloud management device according to the second embodiment.

The information analysis unit 109 acquires the traffic information of the load balancer 200 from the information storage database 111 (Step S401). To be specific, the information analysis unit 109 acquires a total value of the traffic amounts of the load balancers 200.

Further, the information analysis unit 109 determines whether the traffic amount of the load balancer 200 is 0.5 times or less the previously measured traffic amount (Step S402). In a case where the traffic amount is larger than 0.5 times the previous traffic amount (Step S402: No), the information analysis unit 109 proceeds to Step S408.

In contrast, in a case where the traffic amount is 0.5 times or less the previous traffic amount (Step S402: Yes), the information analysis unit 109 determines whether the information of the same event type is stored in the same time zone in the analysis learning database 112 (Step S403). In a case where the information of the same event type is not stored in the same time zone (Step S403: No), the information analysis unit 109 proceeds to Step S407.

In contrast, in a case where the information of the same event type is stored in the same time zone (Step S403: Yes), the information analysis unit 109 calculates the interval between the time of the previous event and the time of the current event, and determines the periodic change point type. The information analysis unit 109 then increments the periodicity counter having the same periodic change point type in the same time zone in the analysis learning database 112 (Step S404).

Next, the information analysis unit 109 determines whether the incremented periodicity counter indicates a threshold or more (Step S405). In a case where the periodicity counter indicates less than a threshold (Step S405: No), the information analysis unit 109 proceeds to Step S408.

In contrast, in a case where the periodicity counter indicates the threshold or more (Step S405: Yes), the information analysis unit 109 sets an entry having the incremented periodicity counter to the periodic change point for decrease (Step S406) and proceeds to Step S408.

Further, the information analysis unit 109 sets the LB scale-in preparation to the analysis learning database 112 (Step S407).

Next, the information analysis unit 109 acquires the traffic information of the virtual machine 300 from the information storage database 111 (Step S408). To be specific, the information analysis unit 109 acquires a total value of the traffic amounts of the virtual machines 300 registered in the load balancer 200.

Next, the information analysis unit 109 determines whether the traffic amount of the virtual machine 300 has been reduced to a state where the virtual machine 300 is reducible (Step S409). In a case where the traffic amount has been reduced to the state where the virtual machine 300 is reducible (Step S409: Yes), the information analysis unit 109 proceeds to Step S411.

In contrast, in a case where the traffic amount has not been reduced to a state where the virtual machine 300 is reducible (Step S409: No), the information analysis unit 109 determines whether the traffic amount of the load balancer 200 has reached the performance lower limit of the virtual machine 300 (Step S410).

In a case where the traffic amount of the load balancer 200 has not reached the performance lower limit of the virtual machine 300 (Step S410: No), the information analysis unit 109 terminates the information analysis processing.

In contrast, in a case where the traffic amount of the load balancer 200 has reached the performance lower limit of the virtual machine 300 (Step S410: Yes), the information analysis unit 109 proceeds to Step S411.

The information analysis unit 109 then determines whether the information of the same event type is stored in the same time zone in the analysis learning database 112 (Step S411). In a case where the information of the same event type is stored in the same time zone (Step S411: Yes), the information analysis unit 109 calculates the interval between the time of the previous event and the time of the current event, and determines the periodic change point type. The information analysis unit 109 then increments the periodicity counter having the same periodic change point type in the same time zone in the analysis learning database 112 (Step S412).

Next, the information analysis unit 109 determines whether the incremented periodicity counter indicates a threshold or more (Step S413). In a case where the periodicity counter indicates less than the threshold (Step S413: No), the information analysis unit 109 terminates the information analysis processing.

In contrast, in a case where the periodicity counter indicates the threshold or more (Step S413: Yes), the information analysis unit 109 sets the entry having the incremented periodicity counter to the periodic change point for decrease (Step S414) and terminates the information analysis processing.

Meanwhile, in a case where the information of the same event type is not stored in the same time zone (Step S411: No), the information analysis unit 109 sets the VM scale-in preparation to the analysis learning database 112 (Step S415).

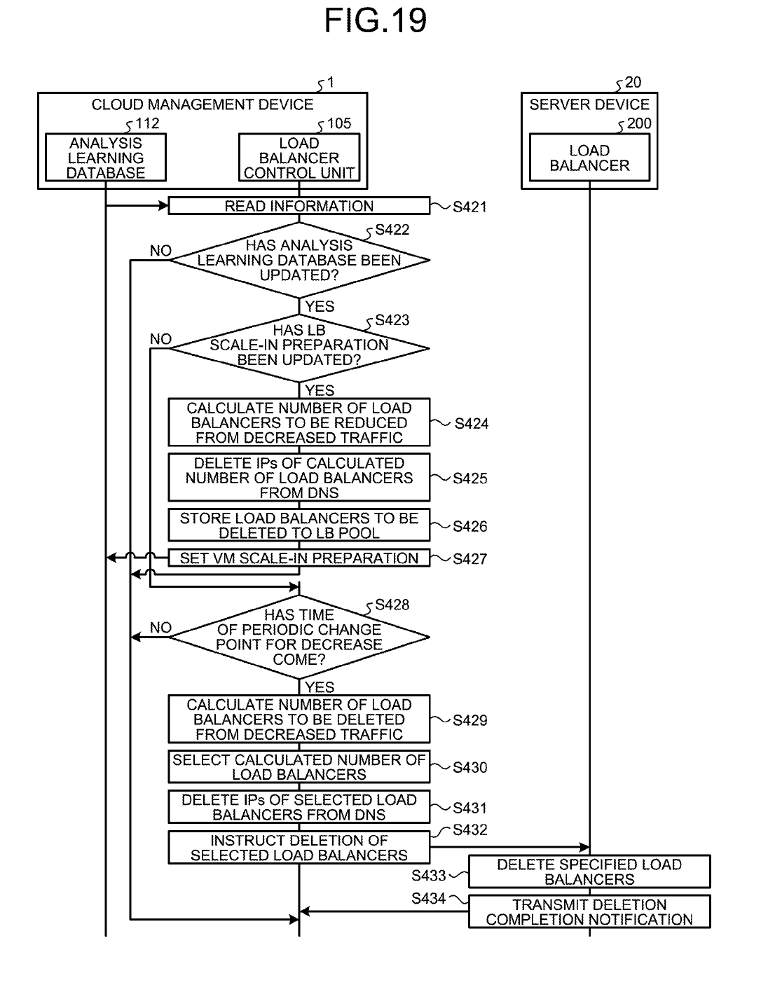

Next, a flow of scale-in processing of the load balancer 200 by the cloud management device 1 according to the present embodiment will be described with reference to FIG. 19. FIG. 19 is a sequence diagram of scale-in processing of the load balancer by the cloud management device according to the second embodiment.

The load balancer control unit 105 reads the information of the analysis learning database 112 (Step S421).

Next, the load balancer control unit 105 determines whether the analysis learning database 112 has been updated (Step S422). In a case where the analysis learning database 112 has not been updated (Step S422: No), the load balancer control unit 105 terminates the scale-in processing.

In contrast, in a case where the analysis learning database 112 has been updated (Step S422: Yes), the load balancer control unit 105 determines whether the LB scale-in preparation has been updated (Step S423). In a case where the LB scale-in preparation has not been updated (Step S423: No), the load balancer control unit 105 proceeds to Step S428.

In contrast, in a case where the LB scale-in preparation has been updated (Step S423: Yes), the load balancer control unit 105 calculates the number of the load balancers 200 to be reduced from the decreased traffic that is a decreased amount of the traffic of the load balancer 200 (Step S424).

Next, the load balancer control unit 105 deletes the IPs of the calculated number of the load balancers 200 from the DNS device 7 (Step S425).

Next, the load balancer control unit 105 stores the load balancers 200 deleted from the DNS device 7 to the LB pool (Step S426).

Next, the load balancer control unit 105 sets the VM scale-in preparation to the analysis learning database 112, and terminates the scale-in processing (Step S427).

Further, in a case where the LB scale-in preparation has not been updated, the load balancer control unit 105 determines whether the time of the periodic change point for decrease has come (Step S428). In a case where the time of the periodic change point for decrease has not come (Step S428: No), the load balancer control unit 105 terminates the scale-in processing.

In contrast, in a case where the time of the periodic change point for decrease has come (Step S428: Yes), the load balancer control unit 105 calculates the number of the load balancers 200 to be reduced from the decreased traffic at the periodic change point for decrease (Step S429).

Next, the load balancer control unit 105 selects the calculated number of the load balancers 200 from the load balancers 200 in operation (Step S430).

Next, the load balancer control unit 105 deletes the IPs of the load balancers 200 from the DNS device 7 (Step S431).

Next, the load balancer control unit 105 instructs the server device 20 to delete the selected load balancers 200 (Step S432).

The server device 20 deletes the specified load balancers 200 (Step S433). The server device 20 then transmits a deletion completion notification of the load balancers 200 to the load balancer control unit 105 (Step S434).

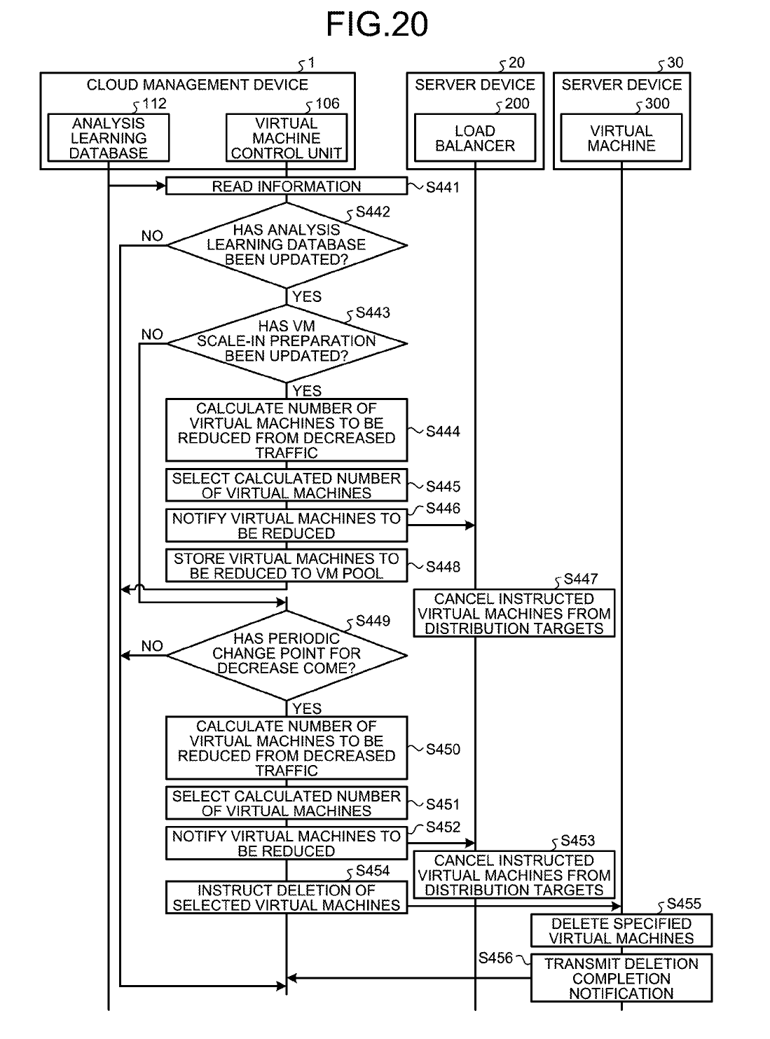

Next, a flow of scale-in processing of the virtual machine 300 by the cloud management device 1 according to the present embodiment will be described with reference to FIG. 20. FIG. 20 is a sequence diagram of scale-in processing of the virtual machine by the cloud management system according to the second embodiment.

The virtual machine control unit 106 reads the analysis learning database 112 (Step S441).

Next, the virtual machine control unit 106 determines whether the analysis learning database 112 has been updated (Step S442). In a case where the analysis learning database 112 has not been updated (Step S442: No), the virtual machine control unit 106 terminates the scale-in processing.

In contrast, in a case where the analysis learning database 112 has been updated (Step S442: Yes), the virtual machine control unit 106 determines whether the VM scale-in preparation has been updated (Step S443). In a case where the VM scale-in preparation has not been updated (Step S443: No), the virtual machine control unit 106 proceeds to Step S449.

In contrast, in a case where the VM scale-in preparation has been updated (Step S443: Yes), the virtual machine control unit 106 calculates the decreased traffic that is a decreased amount of the traffic in the traffic information corresponding to the updated VM scale-in preparation. The virtual machine control unit 106 then calculates the number of the virtual machines 300 to be reduced from the decreased traffic (Step S444).

Next, the virtual machine control unit 106 selects the calculated number of the virtual machines 300 from the virtual machines 300 in operation, and determines the virtual machines 300 to be reduced (Step S445).

Next, the virtual machine control unit 106 notifies the virtual machines 300 to be reduced to the load balancer 200 (Step S446).

Upon reception of the notification of the virtual machines 300 to be reduced, the load balancer 200 cancels the specified virtual machines 300 from the distribution targets (Step S447).

Next, the virtual machine control unit 106 stores the virtual machines 300 to be reduced to the VM pool, and terminates the scale-in processing (Step S448).

Meanwhile, in a case where the VM scale-in preparation has not been updated, the virtual machine control unit 106 determines whether the time of the periodic change point for decrease has come (Step S449). In a case where the time of the periodic change point for decrease has not come (Step S449: No), the virtual machine control unit 106 terminates the scale-in processing.

In contrast, in a case where the time of the periodic change point for decrease has come (Step S449: Yes), the virtual machine control unit 106 calculates the decreased traffic that is a decreased amount of the traffic at the periodic change point for decrease. The virtual machine control unit 106 then calculates the number of the virtual machines 300 to be reduced from the decreased traffic (Step S450).

Next, the virtual machine control unit 106 selects the calculated number of the virtual machines 300 from the virtual machines 300 in operation, and determines the virtual machines 300 to be reduced (Step S451).

Next, the virtual machine control unit 106 notifies the virtual machines 300 to be reduced to the load balancer 200 (Step S452).

Upon reception of the notification of the virtual machines 300 to be reduced, the load balancer 200 cancels the specified virtual machines 300 from the distribution targets (Step S453).

Next, the virtual machine control unit 106 instructs the server device 30 to delete the selected number of the virtual machines 300 (Step S454).

The server device 30 deletes the specified number of the virtual machines 300 (Step S455) upon reception of the instruction of deletion of the virtual machines 300.

After that, the server device 30 transmits the deletion completion notification to the virtual machine control unit 106 (Step S456).

As described above, the cloud management device according to the present embodiment leans timing when change of traffic of a determined amount occurs, and performs autoscale according to change having a high possibility of occurrence at the timing. With the process, periodically occurring sudden change of the traffic amount can be handled, and appropriate autoscale following change of the traffic amount can be performed.

### [c] Third Embodiment

Next, a third embodiment will be described. A cloud management device 1 according to the present embodiment is also illustrated in the block diagram in FIG. 2. The cloud management device 1 according to the present embodiment is different from the second embodiment in learning periodic traffic change and executing scale-out preparation in advance before periodic traffic increase occurs. In the description below, description of functions of units similar to those of the second embodiment is omitted.

A analysis learning database 112 according to the present embodiment includes maximum deployment time information in addition to the analysis learning database 112. The maximum deployment time is a maximum value of time spent on deployment of a load balancer 200 or a virtual machine 300. The maximum deployment time is updated every time deployment is performed, for deployment time of the load balancer 200 and the virtual machine 300. Hereinafter, the time spent on deployment of the load balancer 200 is referred to as “LB deployment time”, and the maximum deployment time in the LB deployment time is referred to as “LB maximum deployment time”. Further, the time spent on deployment of the virtual machine 300 is referred to as “VM deployment time”, and the maximum deployment time in the VM deployment time is referred to as “VM maximum deployment time”.

A load balancer control unit 105 determines whether time has reached time before the LB maximum deployment time from a periodic change point for increase of the load balancer 200, in addition to whether LB scale-out preparation has been updated, at the time of determination as to whether performing scale-out preparation of the load balancer 200. Here, the load balancer control unit 105 can obtain the LB maximum deployment time from the already acquired analysis learning database 112. Then, in a case where the LB scale-out preparation has been updated or in a case where the time has reached time before the LB maximum deployment time from the periodic change point for increase, the load balancer control unit 105 performs the following processing.

The load balancer control unit 105 calculates the number of the load balancers 200 to be added from increased traffic in the load balancer 200. Next, the load balancer control unit 105 instructs a server device 20 to start the calculated number of the load balancers 200. Upon reception of a start completion notification from the server device 20, the load balancer control unit 105 instructs the server device 20 to reflect setting to the added load balancers 200.

The load balancer control unit 105 then measures time to receive a setting reflection completion notification from the instruction of start of the load balancers 200, and employs the measured value as the LB deployment time of this time. Next, the load balancer control unit 105 determines whether the measured value of the LB deployment time is longer than the LB maximum deployment time registered in the analysis learning database 112. In a case where the measured value of the LB deployment time is longer than the LB maximum deployment time, the load balancer control unit 105 changes the LB maximum deployment time registered in the analysis learning database 112 with the measured value of the LB deployment time of this time.

Further, the load balancer control unit 105 stores the added load balancers 200 to an LB pool. Further, the load balancer control unit 105 sets VM scale-out preparation to the analysis learning database 112.

A virtual machine control unit 106 determines whether time has reached time before the VM maximum deployment time from a periodic change point for increase of the virtual machine 300, in addition to whether VM scale-out preparation has been updated, at the time of determination as to whether performing the VM scale-out preparation. Here, the virtual machine control unit 106 can obtain the VM maximum deployment time from the already acquired analysis learning database 112. Then, in a case where the VM scale-out preparation has been updated or in a case where the time has reached time before the VM maximum deployment time from the periodic change point for increase, the virtual machine control unit 106 performs the following processing.

The virtual machine control unit 106 calculates increased traffic in traffic information corresponding to a target event. The virtual machine control unit 106 then calculates the number of the virtual machines 300 to be added from the increased traffic. Next, the virtual machine control unit 106 instructs a server device 30 to start the calculated number of the virtual machines 300. Further, the virtual machine control unit 106 stores the added virtual machines 300 to a VM pool.

Further, the virtual machine control unit 106 measures time to receive a start completion notification from the instruction of start of the virtual machines from the server device 30, and employs the measured value as the VM deployment time of this time. Next, the virtual machine control unit 106 determines whether the measured value of the VM deployment time is longer than the VM maximum deployment time registered in the analysis learning database 112. In a case where the measured value of the VM deployment time is longer than the VM maximum deployment time, the virtual machine control unit 106 changes the VM maximum deployment time registered in the analysis learning database 112 with the measured value of the VM deployment time of this time.

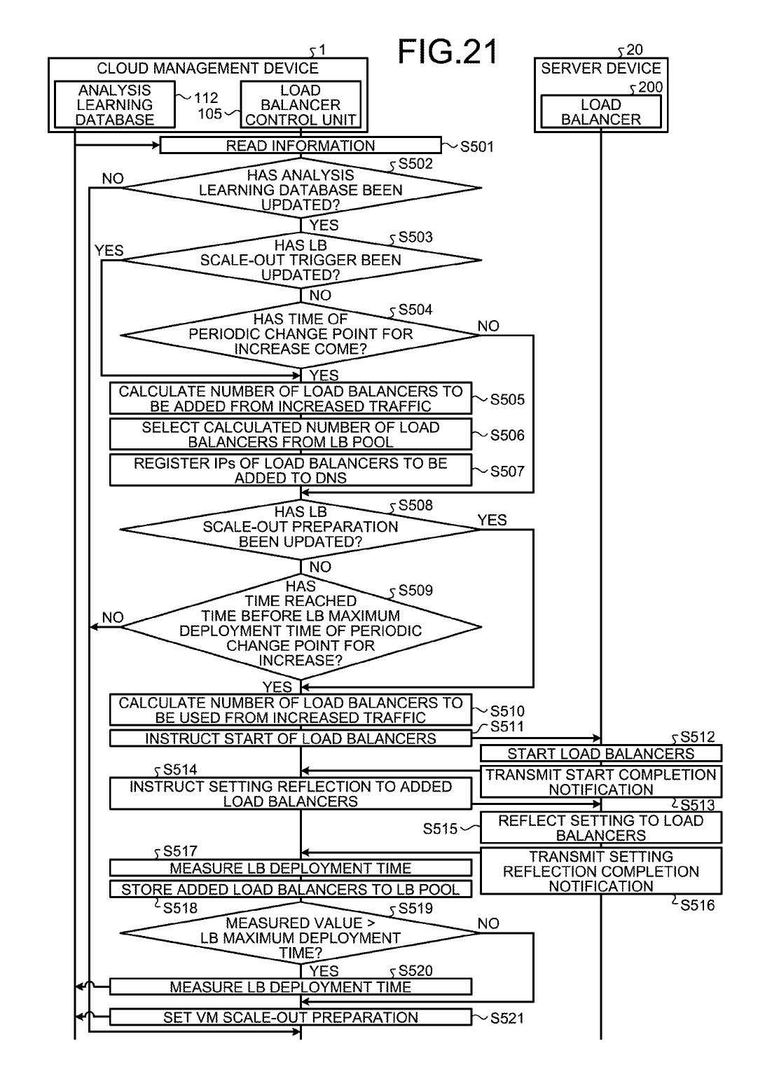

Next, a flow of scale-out processing of the load balancer 200 by the cloud management device 1 according to the present embodiment will be described with reference to FIG. 21. FIG. 21 is a sequence diagram of scale-out processing of a load balancer by a cloud management device according to the third embodiment.

The load balancer control unit 105 reads information of the analysis learning database 112 (Step S501).

Next, the load balancer control unit 105 determines whether the analysis learning database 112 has been updated (Step S502). In a case where the analysis learning database 112 has not been updated (Step S502: No), the load balancer control unit 105 terminates the scale-out processing.

In contrast, in a case where the analysis learning database 112 has been updated (Step S502: Yes), the load balancer control unit 105 determines whether an LB scale-out trigger has been updated (Step S503). In a case where the LB scale-out trigger has been updated (Step S503: Yes), the load balancer control unit 105 proceeds to Step S505.

In contrast, in a case where the LB scale-out trigger has not been updated (Step S503: No), the load balancer control unit 105 determines whether the time of the periodic change point for increase of the load balancer 200 has come (Step S504). In a case where the time of the periodic change point for increase has not come (Step S504: No), the load balancer control unit 105 proceeds to Step S508.

In contrast, in a case where the time of the periodic change point for increase has come (Step S504: Yes), the load balancer control unit 105 calculates the number of the load balancers 200 to be added from the increased traffic (Step S505).

Next, the load balancer control unit 105 selects the calculated number of the load balancers 200 from the LB pool, and determines the selected load balancers 200 as the load balancers 200 to be added (Step S506).

The load balancer control unit 105 then registers the IPs of the load balancers 200 to be added to a DNS device 7 (Step S507).

Next, the load balancer control unit 105 determines whether the LB scale-out preparation has been updated (Step S508). In a case where the LB scale-out preparation has been updated (Step S508: Yes), the load balancer control unit 105 proceeds to Step S510.

In contrast, in a case where the LB scale-out preparation has not been updated (Step S508: No), the load balancer control unit 105 determines whether the time has reached the time before the LB maximum deployment time from the periodic change point for increase of the load balancer 200 (Step S509). In a case where the time has not reached the time before the LB maximum deployment time from the periodic change point for increase (Step S509: No), the load balancer control unit 105 terminates the scale-out processing.

In contrast, in a case where the time has reached the time before the LB maximum deployment time from the periodic change point for increase (Step S509: Yes), the load balancer control unit 105 proceeds to Step S510.

The load balancer control unit 105 then calculates the number of the load balancers 200 to be added from the increased traffic in the traffic information corresponding to the event (Step S510).

Next, the load balancer control unit 105 instructs the server device 20 to start the calculated number of the load balancers 200 (Step S511).

The server device 20 starts the specified number of the load balancers 200 (Step S512) upon reception of the instruction of start of the load balancers 200.

After the start of the load balancers 200, the server device 20 transmits the start completion notification to the load balancer control unit 105 (Step S513).

Upon reception of the start completion notification, the load balancer control unit 105 instructs the server device 20 to reflect the setting to the added load balancers 200 (Step S514).

The server device 20 reflects the specified setting to the added load balancers 200 (Step S515) upon reception of the setting reflection instruction to the load balancers 200.

When the setting reflection to the load balancers 200 has been completed, the server device 20 transmits a setting reflection completion notification to the load balancer control unit 105 (Step S516).

Upon reception of the setting reflection completion notification, the load balancer control unit 105 measures the LB deployment time of this time (Step S517).

Further, the load balancer control unit 105 stores the added load balancers 200 to an LB pool (Step S518).

Next, the load balancer control unit 105 determines whether the measured value of the LB deployment time is longer than the LB maximum deployment time registered in the analysis learning database 112 (Step S519). In a case where the measured value of the LB deployment time is the LB maximum deployment time or less (Step S519: No), the load balancer control unit 105 proceeds to Step S521.

Meanwhile, in a case where the measured value of the LB deployment time is longer than the LB maximum deployment time (Step S519: Yes), the load balancer control unit 105 changes the LB maximum deployment time registered in the analysis learning database 112 with the measured value of the LB deployment time of this time (Step S520).

Further, the load balancer control unit 105 sets the VM scale-out preparation to the analysis learning database 112 (Step S521).

Here, Steps S511 to S520 are executed in parallel in a case where there is a plurality of the load balancers 200.

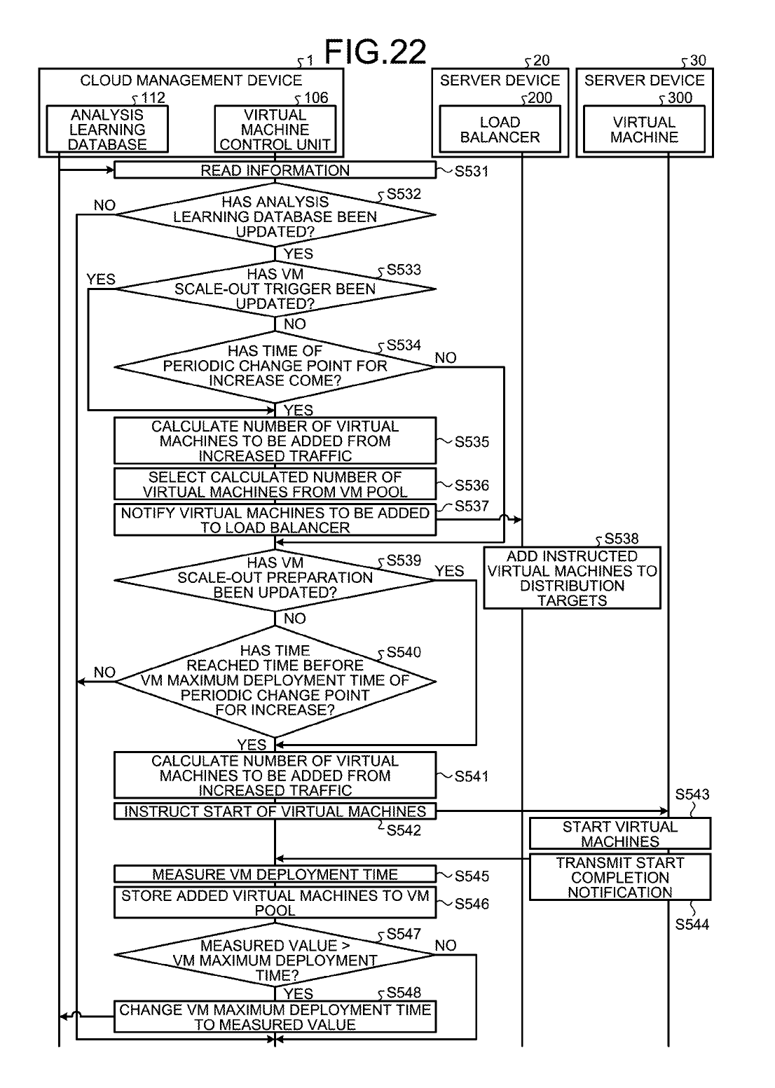

Next, a flow of scale-out processing of the virtual machine 300 by the cloud management device 1 according to the present embodiment will be described with reference to FIG. 22. FIG. 22 is a sequence diagram of scale-out processing of a virtual machine by the cloud management system according to the third embodiment.

The virtual machine control unit 106 reads the analysis learning database 112 (Step S531).

Next, the virtual machine control unit 106 determines whether the analysis learning database 112 has been updated (Step S532). In a case where the analysis learning database 112 has not been updated (Step S532: No), the virtual machine control unit 106 terminates the scale-out processing.

In contrast, in a case where the analysis learning database 112 has been updated (Step S532: Yes), the virtual machine control unit 106 determines whether the VM scale-out trigger has been updated (Step S533). In a case where the VM scale-out trigger has been updated (Step S533: Yes), the virtual machine control unit 106 proceeds to Step S535.

In contrast, in a case where the VM scale-out trigger has not been updated (Step S533: No), the virtual machine control unit 106 determines whether the time of the periodic change point for increase of the virtual machine 300 has come (Step S534). In a case where the time of the periodic change point for increase has not come (Step S534: No), the virtual machine control unit 106 proceeds to Step S539.

In contrast, in a case where the time of the periodic change point for increase has come (Step S534: Yes), the virtual machine control unit 106 calculates the increased traffic in the traffic information corresponding to the target event. The virtual machine control unit 106 then calculates the number of the virtual machines 300 to be added from the increased traffic (Step S535).

Next, the virtual machine control unit 106 selects the calculated number of the virtual machines 300 from the VM pool, and determines the selected virtual machines 300 as the virtual machines 300 to be added (Step S536).

Next, the virtual machine control unit 106 notifies the virtual machines 300 to be added to the load balancer 200 (Step S537).

Upon reception of the notification of the virtual machines 300 to be added, the load balancer 200 adds the specified virtual machines 300 to distribution targets (Step S538).

Next, the virtual machine control unit 106 determines whether the VM scale-out preparation has been updated (Step S539). In a case where the VM scale-out preparation has been updated (Step S539: Yes), the virtual machine control unit 106 proceeds to Step S541.

In contrast, in a case where the VM scale-out preparation has not been updated (Step S539: No), the virtual machine control unit 106 determines whether the time has reached the time before the VM maximum deployment time from the periodic change point for increase of the virtual machine 300 (Step S540). In a case where the time has not reached the time before the VM maximum deployment time from the periodic change point for increase (Step S540: No), the virtual machine control unit 106 terminates the scale-out processing.

In contrast, in a case where the time has reached the time before the VM maximum deployment time from the periodic change point for increase (Step S540: Yes), the virtual machine control unit 106 proceeds to Step S541.

The virtual machine control unit 106 calculates the increased traffic in traffic information corresponding to the target event. The virtual machine control unit 106 then calculates the number of the virtual machines 300 to be added from the increased traffic (Step S541).

Next, the virtual machine control unit 106 instructs the server device 30 to start the calculated number of the virtual machines 300 (Step S542).

The server device 30 starts the specified number of the virtual machines 300 (Step S543) upon reception of the instruction of start of the virtual machines 300.

After the start of the virtual machines 300, the server device 30 transmits the start completion notification to the virtual machine control unit 106 (Step S544).

Upon reception of the start completion notification, the virtual machine control unit 106 measures the VM deployment time of this time (Step S545).

Further, the virtual machine control unit 106 stores the added virtual machines 300 to the VM pool (Step S546).

Next, the virtual machine control unit 106 determines whether the measured value of the VM deployment time is longer than the VM maximum deployment time registered in the analysis learning database 112 (Step S547). In a case where the measured value of the VM deployment time is the VM maximum deployment time or less (Step S547: No), the virtual machine control unit 106 terminates the scale-out processing.

In a case where the measured value of the VM deployment time is longer than the VM maximum deployment time (Step S547: Yes), the virtual machine control unit 106 changes the VM maximum deployment time registered in the analysis learning database 112 with the measured value of the VM deployment time of this time (Step S548).

Here, Steps S542 to S548 are executed in parallel in a case where there is a plurality of the virtual machines 300.

As described above, the cloud management device according to the present embodiment starts preparation of scale out before the maximum time regarding deployment of resources from the time when an increase in the periodic traffic occurs. With the process, the preparation of scale out has already been completed at the time of an increase in the periodic traffic amount, and the scale out can be promptly executed. Therefore, periodically occurring sudden change of the traffic amount can be handled, and appropriate autoscale following change of the traffic amount can be performed.

Hardware Configuration

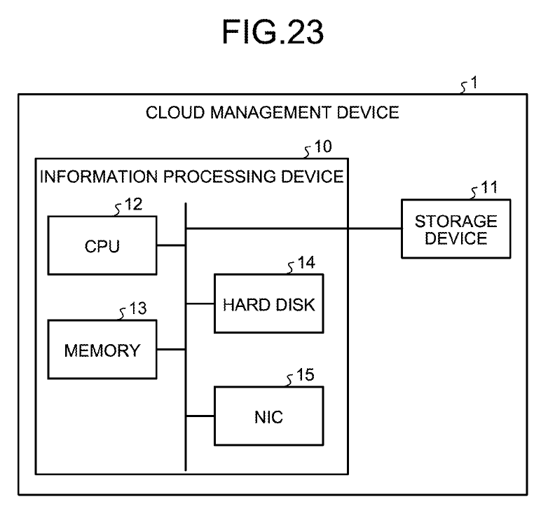

FIG. 23 is a hardware configuration diagram of a cloud management device. As illustrated in FIG. 23, the cloud management device 1 includes an information processing device 10 and a storage device 11. Further, the information processing device 10 includes a central processing unit (CPU) 12, a memory 13, a hard disk 14, and a network interface card (NIC) 15.

The CPU 12 is connected with the memory 13, the hard disk 14, and the NIC 15 through a bus. Further, the CPU 12 is connected with the storage device 11. The CPU 12 transmits/receives data to/from the storage device 11.

The NIC 15 is an interface for being connected to the remote router 6, the network device 4, and the server devices 20 and 30.

The storage device 11 realizes the functions of the information storage database 111, the analysis learning database 112, the resource management database 113, and the pool information storage unit 115 exemplarily illustrated in FIG. 2.

The hard disk 14 realizes the function of the setting parameter storage unit 114 exemplarily illustrated in FIG. 2. Further, the hard disk 14 stores a program that realizes the functions of the user interface control unit 102, the virtual router control unit 103, and the firewall control unit 104 exemplarily illustrated in FIG. 2. Further, the hard disk 14 stores various programs including a program that realizes the functions of the load balancer control unit 105, the virtual machine control unit 106, the remote router information collection unit 107, and the information collection unit 108 exemplarily illustrated in FIG. 2.

For example, the CPU 12 reads out various programs including the program that realizes the functions of the user interface control unit 102, the virtual router control unit 103, and the firewall control unit 104 from the hard disk 14, and expands the programs on the memory 13 and executes the programs. Further, the CPU 12 reads out various programs including the program that realizes the functions of the load balancer control unit 105, the virtual machine control unit 106, the remote router information collection unit 107, and the information collection unit 108 from the hard disk 14, and expands the programs on the memory 13 and executes the programs.

With the processing, the CPU 12 and the memory 13 realize the functions of the user interface control unit 102, the virtual router control unit 103, and the firewall control unit 104 exemplarily illustrated in FIG. 2. Further, the CPU 12 and the memory 13 realizes the functions of the load balancer control unit 105, the virtual machine control unit 106, the remote router information collection unit 107, and the information collection unit 108 exemplarily illustrated in FIG. 2.

Further, the functions of the information storage database 111, the analysis learning database 112, and the resource management database 113 may be realized by the hard disk 14 without using the storage device 11.

Further, here, a case in which the programs are stored in the hard disk 14 in advance has been described. However, the programs for realizing the functions may be stored in a storage medium readable by the cloud management device 1, such as a compact disc (CD) or a digital versatile disc (DVD). In this case, the cloud management device 1 includes a device that reads the storage medium, such as a CD drive or a DVD drive.

According to one aspect of an information processing device, an information processing system, an information processing program, and an information processing method disclosed by the present application, an effect to perform appropriate autoscale according to change of a traffic amount is exhibited.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
an information acquisition unit that acquires information of traffic of a communication processing device and a virtual resource to be used in transmission or reception of data to or from a calculation processing device that operates the virtual resource; and
a control unit that causes the calculation processing device to execute preparation for increase or decrease of the virtual resource on the basis of the information of traffic of the communication processing device and causes the calculation processing device to increase or decrease the virtual resource on the basis of the information of traffic of the virtual resource.

2. The information processing device according to claim 1, further comprising:
an information analysis unit that identifies change of the traffic that periodically occurs, on the basis of the information of traffic acquired by the information acquisition unit, wherein
the control unit causes the calculation processing device to execute the preparation for increase or decrease of the virtual resource and to increase or decrease the virtual resource on the basis of the change of the traffic identified by the information analysis unit.

3. The information processing device according to claim 2, wherein the control unit measures deployment time of the virtual resource by the calculation processing device and identifies increase timing of the periodic traffic of the calculation processing device from the change of the traffic identified by the information analysis unit, and causes the calculation processing device to execute the preparation for increase or decrease of the virtual resource before the deployment time from the increase timing.

4. The information processing device according to claim 1, wherein the control unit causes the calculation processing device to generate the virtual resource to execute preparation for increase of the virtual resource, calculates a number of the virtual resources to increase on the basis of the information of traffic of the communication processing device, and causes the calculation processing device to generate the insufficient virtual resource when the number of the virtual resources prepared for increase by the calculation processing device is smaller than the calculated number.

5. The information processing device according to claim 1, wherein
the virtual resource is a load balancer, and
the control unit causes the calculation processing device to generate the load balancer to execute preparation for increase of the load balancer, and causes the calculation processing device to execute name solution of the load balancer generated in the preparation for increase of the load balancer to increase the load balancer.

6. The information processing device according to claim 1, wherein
the virtual resource is a virtual machine, and
the control unit causes the calculation processing device to generate the virtual machine to execute preparation for increase of the virtual machine, and causes the calculation processing device to register the virtual machine generated in the preparation for increase of the virtual machine to a device that mediates transmission or reception of data to or from the virtual machine to increase the virtual machine.

7. An information processing system comprising: a calculation processing device, a communication processing device, and a management device, wherein
the calculation processing device operates a virtual resource,
the communication processing device is used for transmission or reception of data to or from the calculation processing device, and
the management device includes
an information acquisition unit that acquires information of traffic of the communication processing device and the virtual resource, and
a control unit that causes the calculation processing device to execute preparation for increase or decrease of the virtual resource on the basis of the information of traffic of the communication processing device and to cause the calculation processing device to increase or decrease the virtual resource on the basis of the information of traffic of the virtual resource.

8. An information processing method comprising:
acquiring information of traffic of a communication processing device and a virtual resource to be used in transmission or reception of data to or from a calculation processing device that operates the virtual resource;
causing the calculation processing device to execute preparation for increase or decrease of the virtual resource on the basis of the information of traffic of the communication processing device; and
causing the calculation processing device to increase or decrease the virtual resource on the basis of the information of traffic of the virtual resource.

9. A non-transitoly computer-readable recording medium having stored therein a program that causes a computer to execute an information processing process comprising:
acquiring information of traffic of a communication processing device and a virtual resource to be used in transmission or reception of data to or from a calculation processing device that operates the virtual resource;
causing the calculation processing device to execute preparation for increase or decrease of the virtual resource on the basis of the information of traffic of the communication processing device; and
causing the calculation processing device to increase or decrease the virtual resource on the basis of the information of traffic of the virtual resource.
